(19) United States
(12) Patent Application Publication
(10) Pub. No.: US 2016/0315839 A1
(43) Pub. Date: Oct. 27, 2016

(54) TRANSMISSION METHOD, TRANSMISSION SYSTEM, AND TRANSMISSION DEVICE

(71) Applicant: FUJITSU LIMITED, Kawasaki-shi (JP)

(72) Inventors: Tatsuya KAWASUMI, Yokohama (JP); Kazuhiro Shibuya, Fujisawa (JP); Masayuki ONO, Kawasaki (JP)

(73) Assignee: FUJITSU LIMITED, Kawasaki-shi (JP)

(21) Appl. No.: 15/093,161

(22) Filed: Apr. 7, 2016

(30) Foreign Application Priority Data
Apr. 21, 2015 (JP) 2015-087131

(51) Int. Cl. H04L 12/26; H04L 12/709

(52) U.S. Cl. CPC H04L 43/0835; H04L 45/245

(57) ABSTRACT

A transmission method includes notifying, by a first transmission device, a number of packets transmitted from the first transmission device to the second transmission device via the first communication line, of the second transmission device; storing the number of the transmitted packets; notifying, by a second transmission device, a number of packets received from the first transmission device via the first communication line, of the first transmission device; storing the number of the received packets; and when an operation system is switched from the first communication line to the second communication line, initiating, by the first transmission device, counting of a number of packets transmitted from the first transmission device to the second transmission device using the number of transmitted packets; and initiating, by the second transmission device, counting of a number of packets received from the first transmission device using the number of received packets.

### CROSS-REFERENCE TO RELATED APPLICATION

This application is based upon and claims the benefit of priority of the prior Japanese Patent Application No. 2015-087131, filed on Apr. 21, 2015, the entire contents of which are incorporated herein by reference.

### FIELD

The embodiments discussed herein are related to a transmission method, a transmission system and a transmission device.

### BACKGROUND

As an operation administration and maintenance (OAM) function of a transmission device that transmits and receives packets, the measurement of packet loss, which is a loss number of packets, is known. For example, in International Telecommunication Standardization Sector (ITU-T) recommendation Y.1731, an Ethernet (registered trademark, omitted hereafter) OAM function is defined.

For example, a transmission device reports to another packet transmitting target transmission device by including a number of transmitted packets and a number of received packets, which are counted by the transmission device, in OAM packets. Each transmission device measures packet loss using the reported number of transmitted packets and the number of received packets. There are cases in which a communication line between transmission devices is duplicated in order to protect against the occurrence of failures and the like (for example, refer to Japanese Laid-open Patent Publication No. 2001-127765 and Japanese Laid-open Patent Publication No. 2008-131615).

In a case in which packets are sent and received by a duplicated communication line, for example, if the communication line is switched as a result of the occurrence of a failure, a transmission device initiates the counting of the number of transmitted packets and the number of received packets afresh for the communication line after switching. Therefore, since it is not possible for a transmission device to continue the measurement of packet loss based on the number of transmitted packets and the number of received packets, which are counted for the communication line before switching, an error occurs in the measurement results. Therefore, it is desirable that it is possible to continue the measurement of packet loss even if the communication line is switched.

### SUMMARY

According to an aspect of the invention, a transmission method executed by a transmission system including a first transmission device, a second transmission device, a first communication line and a second communication line, the first communication line and the second communication line are provided between the first transmission device and the second transmission device, the transmission method includes notifying, by the first transmission device, a number of packets transmitted from the first transmission device to the second transmission device via the first communication line, of the second transmission device at a predetermined interval; storing the number of the transmitted packets in association with the second communication line; notifying, by the second transmission device, a number of packets received from the first transmission device via the first communication line, of the first transmission device at a predetermined interval; storing the number of the received packets in association with the second communication line; and when an operation system is switched from the first communication line to the second communication line, initiating, by the first transmission device, counting of a number of packets transmitted from the first transmission device to the second transmission device via the second communication line using the number of transmitted packets stored in association with the second communication line set as an initial value; and initiating, by the second transmission device, counting of a number of packets received from the first transmission device via the second communication line using the number of received packets stored in association with the second communication line set as an initial value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram that illustrates an example of a transmission system;

FIG. 2 is a configuration diagram that illustrates an example of a transmission device;

FIG. 3A is a diagram that illustrates an example of a counter table of an operation system line unit;

FIG. 3B is a diagram that illustrates an example of a counter table of a standby system line unit;

FIG. 3C is a diagram that illustrates an example of a packet loss table;

FIG. 3D is a diagram that illustrates an example of a LAG settings table;

FIG. 4 is a configuration drawing that illustrates an example of packets that are sent and received between line units;

FIG. 5 is a sequence diagram that illustrates measurement actions of packet loss at a normal time in a comparative example;

FIG. 6 is a sequence diagram that illustrates measurement actions of packet loss when packet loss occurs in a comparative example;

FIG. 7 is a sequence diagram that illustrates measurement actions of packet loss when failure occurs in a comparative example;

FIG. 8 is a sequence diagram that illustrates measurement actions of packet loss at a normal time in an embodiment;

FIG. 9 is a diagram that illustrates a pathway of an OAM packet in one transmission device;

FIG. 10 is a diagram that illustrates a pathway of an OAM packet in the other transmission device;

FIG. 11A is a diagram that illustrates a change in a counter table of an operation system line unit;

FIG. 11B is a diagram that illustrates a change in a counter table of a standby system line unit;

FIG. 12 is a sequence diagram that illustrates measurement actions of packet loss when failure occurs in an embodiment (No. 1); and

FIG. 13 is a sequence diagram that illustrates measurement actions of packet loss when failure occurs in the embodiment (No. 2).

### DESCRIPTION OF EMBODIMENTS

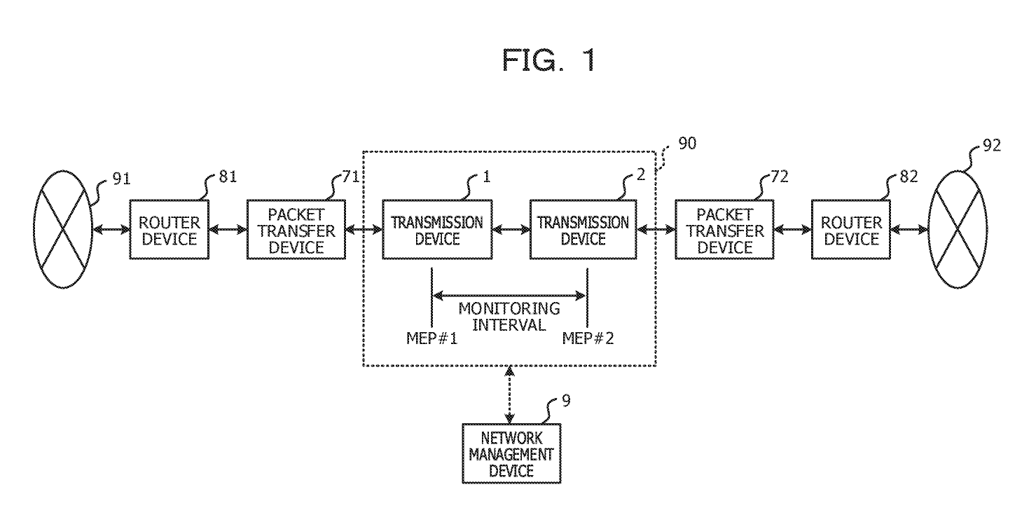

FIG. 1 is a configuration diagram that illustrates an example of a transmission system. The transmission system includes transmission devices 1 and 2, packet transfer devices 71 and 72, and router devices 81 and 82.

The router devices 81 and 82 are respectively provided between the packet transfer devices 71 and 72, and local area networks (LANs) 91 and 92. The router devices 81 and 82 respectively transfer packets that are received from the packet transfer devices 71 and 72, and the LANs 91 and 92 in accordance with a routing table that indicates a transmission pathway of packets.

The packet transfer devices 71 and 72 are respectively provided between the transmission devices 1 and 2, and the router devices 81 and 82. For example, the packet transfer devices 71 and 72 are layer 2 switches. The packet transfer devices 71 and 72 respectively transfer packets that are received from the transmission devices 1 and 2, and the router devices 81 and 82 in accordance with a packet destination.

The transmission devices 1 and 2 are provided within a trunk network 90, and are connected to one another via a transmission path such as an optical fiber. For example, the transmission devices 1 and 2 are Packet Optical Networking Platform (P-ONP) devices. The transmission devices 1 and 2 respectively transmit packets that are received from the packet transfer devices 71 and 72 to the other transmission device 2 or 1. The transmission devices 1 and 2 respectively transmit packets that are received from the other transmission device 2 or 1 to the packet transfer devices 71 and 72.

That is, the transmission devices 1 and 2 transmit and receive packets to one another. As a result of this, communication terminals (for example, smartphones or the like) within different LANs 91 and 92 can communicate via the transmission devices 1 and 2. In the present embodiment, for example, the packets are Ethernet frame, or internet protocol (IP) packets, asynchronous transfer mode (ATM) cells or the like. In addition to just P-ONP devices, computer devices such as servers are also included in the transmission devices 1 and 2.

In the present embodiment, a maintenance end point (MEP) that is defined in recommendation Y.1731 of the ITU-T is respectively set in the transmission devices 1 and 2 (refer to “MEP #1” and “MEP #2”), and a period between MEP #1 and MEP #2 is set as a monitoring segment of OAM function. Accordingly, a network management device 9, which manages the trunk network 90, accumulates a loss number of packets that are sent and received between the transmission devices 1 and 2, that is, measurement results of packet loss, from the transmission devices 1 and 2. Hereinafter, the configurations of the transmission devices 1 and 2 will be described.

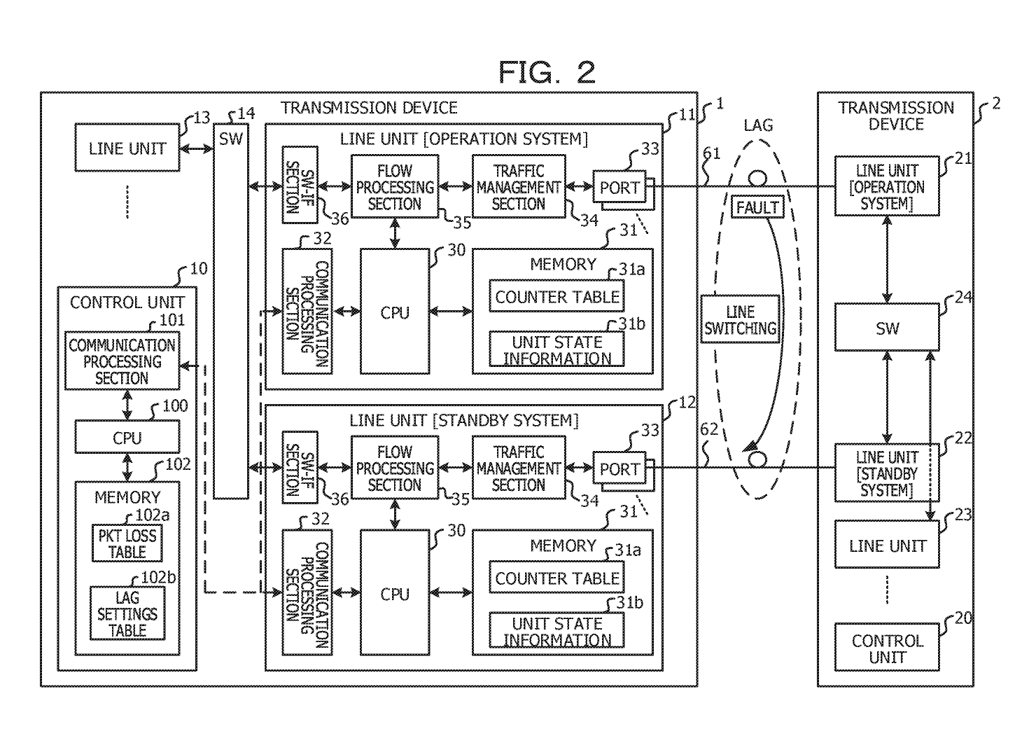

FIG. 2 is a configuration diagram that illustrates an example of the transmission devices 1 and 2. The transmission devices 1 and 2 transmit and receive packets to one another via an operation system communication line (a first communication line) 61 or a standby system communication line (a second communication line) 62. The communication line 61 and the communication line 62 are configured as communication lines that are duplicated using link aggregation. That is, the communication line 61 and the communication line 62 belong to a shared link aggregation group (LAG).

The transmission devices 1 and 2 generally transmit and receive packets to one another via the operation system communication line 61. For example, in a case in which a failure occurs in the operation system communication line 61, the transmission devices 1 and 2 transmit and receive packets to one another via the standby system communication line 62 by switching the communication line that is used from the operation system to the standby system. In this manner, the transmission system forms a logical path for transmitting packets by logically controlling the communication lines 61 and 62, which are provided between the transmission devices 1 and 2.

A logical path for transmitting packets by logically controlling the communication lines 61 and 62, which are provided between the other transmission devices 2 and 1, is formed in each of the transmission devices 1 and 2. If viewed from a transmission direction that runs from the transmission device 1 toward the transmission device 2, the transmission device 1 is a first transmission device that transmits packets via the operation system communication line 61 or the standby system communication line 62. The transmission device 2 is a second transmission device that receives packets via the operation system communication line 61 or the standby system communication line 62.

The transmission device 1 includes a control unit 10, a plurality of line units 11 to 13, and a switching unit (SW) 14. In the same manner as the transmission device 1, the transmission device 2 includes a control unit 20, a plurality of line units 21 to 23, and a switching unit (SW) 24. Each unit 10 to 14 of the transmission device 1 is an example of a first unit. Each unit 20 to 24 of the transmission device 2 is an example of a second unit. In FIG. 2, of the line units 11 to 13 and 21 to 23, only the configurations of the line units 11 and 13 are illustrated. However, the line units 13 and 21 to 23 also have the same configurations. In FIG. 2, of the control units 10 and 20, only the configuration of the control unit 10 is illustrated. However, the control unit 20 also has the same configuration.

The line unit 11 of the transmission device 1 and the line unit 21 of the transmission device 2 transmit and receive packets to one another via the communication line 61. The line unit 12 of the transmission device 1 and the line unit 22 of the transmission device 2 transmit and receive packets to one another via the communication line 62. In other words, the line units 11 and 21 process communication via the communication line 61. The line units 12 and 22 process communication via the communication line 62.

In the transmission device 1, the switching unit 14 interchanges packets between the plurality of line units 11 to 13. Therefore, the plurality of line units 11 to 13 transmit and receive packets to one another via the switching unit 14. For example, the line unit 13 transmits packets, which are received from the packet transfer device 71 in FIG. 1, to the line unit 11 via the switching unit 14. The line unit 13 transmits packets, which are received from the line unit 11, to the packet transfer device 71 via the switching unit 14.

Meanwhile, in the transmission device 2 also, the plurality of line units 21 to 23 transmit and receive packets to one another via the switching unit 24. For example, the line unit 23 transmits packets, which are received from the packet transfer device 72 in FIG. 1, to the line unit 21 via the switching unit 24. The line unit 23 transmits packets, which are received from the line unit 21, to the packet transfer device 72 via the switching unit 24.

The line units 11 to 13 and 21 to 23 respectively include a central processing unit (CPU) 30, a memory 31, a communication processing section 32, a plurality of ports 33, a traffic management section 34, a flow processing section 35, and a switch interface (SW-IF) section 36. The plurality of ports 33 are provided with processing functions of Ethernet physical layers (PHY) and media access control (MAC) layers. The plurality of ports 33 transmit and receive packets to and from other devices.

A single port 33 of the line unit 11 and a single port 33 of the line unit 21 configure the communication line 61 as a result of being connected to one another. A single port 33 of the line unit 12 and a single port 33 of the line unit 22 configure the communication line 62 as a result of being connected to one another. The ports 33 output packets, which are received from the other transmission device 1 or 2, to the traffic management section 34. The ports 33 transmit packets, which are input from the traffic management section 34, to the other transmission device 1 or 2.

For example, the traffic management section 34 has a function of a shaper or the like, and manages a packet band. The traffic management section 34 outputs packets, which are input from the ports 33, to the flow processing section 35. The traffic management section 34 outputs packets, which are input from the flow processing section 35, to the ports 33.

The flow processing section 35 performs a sorting process of packets depending on packet type. The packets include user packets, which include user data, and OAM packets, which include data that relates to an OAM between MEP #1 and MEP #2. The flow processing section 35 outputs packets, which are input from the traffic management section 34, to the SW-IF section 36. The flow processing section 35 outputs packets, which are input from the SW-IF section 36, to the traffic management section 34.

The flow processing section 35 outputs OAM packets, which are input from the traffic management section 34, to the CPU 30 and the SW-IF section 36. The flow processing section 35 outputs OAM packets, which are input from the SW-IF section 36, to the CPU 30. Furthermore, the flow processing section 35 outputs OAM packets, which are input from the CPU 30, to the traffic management section 34 and the SW-IF section 36.

The SW-IF section 36 transmits and receives packets to and from the switching units 14 and 24. The SW-IF section 36 outputs packets, which are input from the switching units 14 and 24, to the flow processing section 35. The SW-IF section 36 outputs packets, which are input from the flow processing section 35, to the switching units 14 and 24. The switching units 14 and 24 transfer user packets, which are input from the SW-IF section 36, to the line units 11 to 13 and 21 to 23 according to a packet destination in accordance with settings from the control units 10 and 20.

For example, in a case in which user packets, for which a communication terminal within the LAN 91 is set as the destination, are input from the line unit 11, the switching unit 14 of the transmission device 1 transfers the user packets to the line unit 13. For example, in a case in which user packets, for which a communication terminal within the LAN 92 is set as the destination, are input from the line unit 21, the switching unit 24 of the transmission device 2 transfers the user packets to the line unit 23.

The switching units 14 and 24 transfer OAM packets, which are input from the SW-IF section 36, to the standby system line units 12 and 22 that correspond to the operation system line units 11 and 21 of the input source of the OAM packets in accordance with settings from the control units 10 and 20. The switching unit 14 of the transmission device 1 transfers OAM packets, which are input from the operation system line unit 11, to the standby system line unit 12. Meanwhile, the switching unit 24 of the transmission device 1 transfers OAM packets, which are input from the operation system line unit 21, to the standby system line unit 22.

The CPU 30 is driven by software, and controls the overall actions of the line units 11 to 13 and 21 to 23. The memory 31 is connected to the CPU 30 via wiring such as a bus. The communication processing section 32 processes communication between the CPU 30 and the control units 10 and 20. Hardware such as a field programmable gate array (FPGA) may be provided in place of the CPU 30.

A counter table 31a and unit state information 31b is retained in the memory 31. Another information maintenance unit such as a hard disk drive (HDD) may be used in place of the memory 31. A number of transmitted packets and a number of received packets, which are used in the measurement of packet loss, are recorded in the counter table 31a. The unit state information 31b indicates whether or not the line units 11 to 13 and 21 to 23 are operation system or standby system.

In the example of FIG. 2, the unit state information 31b of the operation system line units 11 and 21 indicates the “operation system”. The unit state information 31b of the standby system line units 12 and 22 indicates the “standby system”. In a case in which the unit state information 31b indicates the “operation system”, the CPU 30 allows a transmitting and receiving process of packets to and from the other transmission device 1 or 2 for each section, such as the flow processing section 35 and the like, of the line units 11 to 13 and 21 to 23. Meanwhile, in a case in which the unit state information 31b indicates the “standby system”, the CPU 30 does not allow the transmitting and receiving process.

The unit state information 31b is set by the control units 10 and 20. The CPU 30 receives the unit state information 31b from the control units 10 and 20 via the communication processing section 32, and writes the unit state information 31b to the memory 31.

The CPU 30 updates the counter table 31a each time OAM packets are sent and received. Further, the CPU 30 transmits each numerical value within the counter table 31a to the control units 10 and 20. The control units 10 and 20 retain each numerical value, which is received from the CPU 30, and uses the numerical values in the measurement of packet loss.

For the measurement of packet loss, the CPU 30 performs a creation process, a transmitting process, and a reception process of OAM packets. In the operation system line units 11 and 21, the CPU 30 counts the number of transmitted OAM packets and the number of received OAM packets. Further, the CPU 30 creates OAM packets, which include at least one of the number of transmitted OAM packets and the number of received OAM packets, and transmits the OAM packets to the other transmission device 2 or 1. The CPU 30 records the counted number of transmitted OAM packets and the number of received OAM packets in the counter table 31a, which is retained in the memory 31. Further, the CPU 30 acquires at least one of the number of transmitted OAM packets and the number of received OAM packets, which the other transmission device 2 or 1 has counted, from the OAM packets, which have been received from the transmission device 2 and 1, and records the information in the counter table 31a.

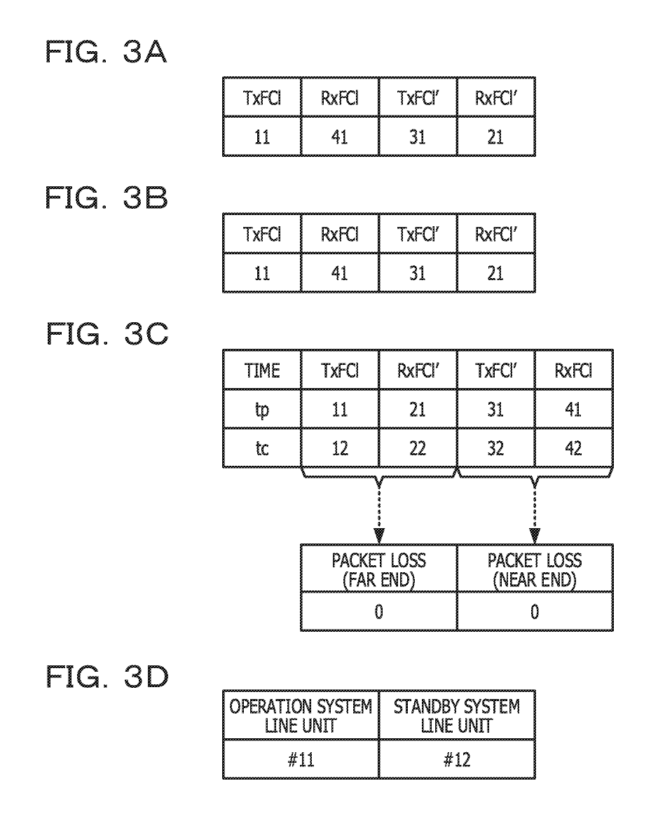

An example of the counter table 31a of the operation system line unit 11 is illustrated in FIG. 3A. Each numerical value of TxFCI, RxFCI, TxFCI′ and RxFCI′ is recorded in the counter table 31a.

The TxFCI is a number of OAM packets, which the line unit 11 has sent to the line unit 21 of the other transmission device 2. The RxFCI is a number of OAM packets, which the line unit 11 has received from the line unit 21 of the other transmission device 2. In other words, the TxFCI indicates the number of transmitted OAM packets of the line unit 11. The RxFCI indicates the number of received OAM packets of the line unit 11.

The CPU 30 of the line unit 11 updates the TxFCI each time an OAM packet is sent to the line unit 21 of the other transmission device 2. Further, the CPU 30 updates the RxFCI each time an OAM packet is received from the line unit 21. As a result of this, the number of transmitted OAM packets and the number of received OAM packets are counted.

The TxFCI′ is a number of OAM packets, which the line unit 21 of the other transmission device 2 has sent to the line unit 11. The RxFCI′ is a number of OAM packets, which the line unit 21 has received from the line unit 11. In other words, the TxFCI′ indicates the number of transmitted OAM packets of the line unit 21. The RxFCI′ indicates the received number of OAM packets of the line unit 21.

The TxFCI′ and the RxFCI′ are included in OAM packets that are received from the line unit 21 of the other transmission device 2. The CPU 30 updates the TxFCI′ and the RxFCI′ in the counter table 31a each time an OAM packet is received from the line unit 21.

As will be described later, both the TxFCI′ and the RxFCI′ are included in OAM packets, which are sent to the transmission device 1 from the transmission device 2. Meanwhile, the TxFCI is included in OAM packets, which are sent to the transmission device 2 from the transmission device 1, but the RxFCI is not included. Therefore, the RxFCI is not included in the counter table 31a of the operation system line unit 21 of the other transmission device 2.

The CPU 30 of the line unit 21 updates the TxFCI′ each time an OAM packet is sent to the line unit 11 of the other transmission device 1. Further, the CPU 30 updates the RxFCI′ each time an OAM packet is received from the line unit 11. As a result of this, in the line unit 21 also, in the same manner as the line unit 11, the number of transmitted OAM packets and the number of received OAM packets are counted.

The CPU 30 of the line unit 21 updates the TxFCI in the counter table 31a each time an OAM packet is received from the line unit 11. The transmitting and receiving of OAM packets is performed at regular intervals.

In this manner, as an example of a first line processing section, the operation system line unit 11 of the transmission device 1 counts the number of transmitted OAM packets for the communication line 61, and reports the number of transmitted OAM packets to the other transmission device 2 at regular intervals. Meanwhile, as an example of a third line processing section, the operation system line unit 21 of the transmission device 2 counts the received number of OAM packets for the communication line 61, and reports the number of transmitted OAM packets to the other transmission device 1 at regular intervals.

An example of the counter table 31a of the standby system line unit 12 is illustrated in FIG. 3B. In the same manner as the counter table 31a of the operation system line unit 11, each numerical value of TxFCI, RxFCI, TxFCI′ and RxFCI′ is recorded in the counter table 31a of the standby system line unit 12. The RxFCI is not included in the counter table 31a of the standby system line unit 22 of the other transmission device 2 for the above-mentioned reason.

In a case in which an operation system is switched from the communication line 61 to the communication line 62, the standby system line units 12 and 22 update the counter table 31a in the same manner as the operation system line units 11 and 21.

The CPU 30 of the line unit 12 of the transmission device 1 updates the TxFCI each time an OAM packet is sent to the line unit 22 of the other transmission device 2. Further, the CPU 30 updates the RxFCI each time an OAM packet is received from the line unit 22. The CPU 30 of the line unit 12 updates the TxFCI′ and the RxFCI′ in the counter table 31a each time an OAM packet is received from the line unit 22 of the other transmission device 2.

In the other transmission device 2, the CPU 30 of the line unit 22 updates the TxFCI′ each time an OAM packet is sent to the line unit 12 of the transmission device 1. Further, the CPU 30 updates the RxFCI′ each time an OAM packet is received from the line unit 12. The CPU 30 of the line unit 22 updates the TxFCI in the counter table 31a each time an OAM packet is received from the line unit 12.

In this manner, as an example of a second line processing section, the standby system line unit 12 of the transmission device 1 counts the number of transmitted OAM packets for the communication line 62, and reports the number of transmitted OAM packets to the other transmission device 2 at regular intervals. Meanwhile, as an example of a fourth line processing section, the standby system line unit 22 of the transmission device 2 counts the received number of OAM packets for the communication line 62, and reports the number of transmitted OAM packets to the other transmission device 1 at regular intervals.

Before an operation system is switched from the communication line 61 to the communication line 62, the standby system line units 12 and 22 update the counter table 31a to respectively match the counter tables 31a of the operation system line units 11 and 21.

In the transmission device 1, the standby system line unit 12 respectively updates the TxFCI and the RxFCI in the counter table 31a of the transmission device 1 to match the TxFCI and the RxFCI, which are counted by the operation system line unit 11. The standby system line unit 12 respectively updates the TxFCI′ and the RxFCI′ in the counter table 31a of the transmission device 1 to match the TxFCI′ and the RxFCI′, which are included in the OAM packets that the operation system line unit 11 receives.

As a result of this, the TxFCI, the RxFCI, the TxFCI′, and the RxFCI′ in the counter table 31a are synchronized between the operation system line unit 11 and the standby system line unit 12. In other words, the numerical values of each counter table 31a of the operation system line unit 11 and the standby system line unit 12 become the same as illustrated in FIG. 3A and FIG. 3B.

In the transmission device 2, the standby system line unit 22 respectively updates the TxFCI′ and the RxFCI′ in the counter table 31a of the transmission device 2 to match the TxFCI′ and the RxFCI′, which are counted by the operation system line unit 21. The standby system line unit 22 updates the TxFCI′ in the counter table 31a of the transmission device 2 to match the TxFCI, which is included in the OAM packets that the operation system line unit 21 receives.

As a result of this, the TxFCI, the TxFCI′, and the RxFCI′ in the counter table 31a are synchronized between the operation system line unit 21 and the standby system line unit 22. In other words, the numerical values of each counter table 31a of the operation system line unit 21 and the standby system line unit 22 become the same. The details of this synchronization process will be described later.

In the transmission device 1 each numerical value in the counter table 31a of the operation system line unit 11 is sent to the control unit 10, and used in the measurement of packet loss. In the transmission device 2 each numerical value in the counter table 31a of the operation system line unit 21 is sent to the control unit 20, and used in the measurement of packet loss. In a case in which the operation system switches from the communication line 61 to the communication line 62, each numerical value in the counter table 31a of the standby system line units 12 and 22 is respectively sent to the control units 10 and 20, and used in the measurement of packet loss.

As illustrated in FIG. 2, the control units 10 and 20 include a CPU 100, a communication processing section 101, and a memory 102.

The CPU 100 is driven by software, and controls the overall actions of the control units 10 and 20. The memory 102 is connected to the CPU 100 via wiring such as a bus. The communication processing section 101 processes communication between the CPU 100 and the line units 11 to 13 and 21 to 23. Hardware such as an FPGA may be provided in place of the CPU 100.

A packet (PKT) loss table 102a and a LAG settings table 102b are retained in the memory 102. Each numerical value, which is acquired from the counter tables 31a of the operation system line units 11 and 21, and values of packet loss, which are calculated from the numerical values are recorded in the PKT loss table 102a.

An example of the PKT loss table 102a is illustrated in FIG. 3C. In the present example, description will be given using the PKT loss table 102a of the transmission device 1 as an example.

The TxFCI, RxFCI, TxFCI′ and RxFCI′ of a current time tc, the TxFCI, RxFCI, TxFCI′ and RxFCI′ of a preceding time tp, and packet loss of a far end and a near end are recorded in the PKT loss table 102a. In the case of the transmission device 2, the TxFCI and RxFCI′ of a current time tc, the TxFCI and RxFCI′ of a preceding time tp, and packet loss of the near end are recorded in the PKT loss table 102a.

Each numerical value of the current time tc is a most recent numerical value, that is, a numerical value that was acquired on the current occasion. Each numerical value of the preceding time tp precedes the most recent numerical value, that is, is a numerical value that was acquired on the preceding occasion. When each numerical value in the counter table 31a is acquired from the line unit 11, the CPU 100 updates each numerical value of the preceding time tp to each numerical value of the current time tc, and updates each numerical value of the current time tc to each acquired numerical value.

In other words, when new TxFCI, RxFCI, TxFCI′ and RxFCI′ are acquired, the CPU 100 records each numerical value of the preceding time tp as each numerical value of the current time tc. Further, the CPU 100 records each acquired numerical value as each numerical value of the current time tc. As a result of this, the TxFCI, RxFCI, TxFCI′ and RxFCI′, which were acquired on this occasion, and the TxFCI, RxFCI, TxFCI′ and RxFCI′, which were acquired on a preceding occasion, are recorded in the PKT loss table 102a. In a case in which the communication line that is used is switched from the operation system communication line 61 to the standby system communication line 62, the CPU 100 acquires each numerical value from the standby system line unit 12.

The packet loss of the far end is a loss number of OAM packets in a transmission direction from the transmission device 1 to the transmission device 2. The CPU 100 calculates the packet loss of the far end using the TxFCI and RxFCI′ of the current time tc, and the TxFCI and RxFCI′ of the preceding time tp.

LSf={TxFCI(tc)−TxFCI(tp)}−{(RxFCI′(tc)−RxFCI′(tp)} (1)

The packet loss of the far end LSf is calculated using Formula (1) mentioned above. In this instance, TxFCI (tc) is the TxFCI of the current time tc, and TxFCI (tp) is the TxFCI of the preceding time tp. In this instance, RxFCI′ (tc) is the RxFCI′ of the current time tc, and RxFCI′ (tp) is the RxFCI′ of the preceding time tp.

In the example of FIG. 3C, TxFCI (tc)=12, TxFCI (tp)=11, RxFCI′ (tc)=22 and RxFCI′ (tp)=21. Therefore, the LSf=(12−11)−(22−21)=0.

In this manner, in the transmission device 1, the CPU 100 calculates the packet loss of the far end LSf from a difference between the number of transmitted OAM packets of the line unit 11, and the received number of OAM packets of the line unit 21 of the other transmission device 2. In the other transmission device 2, the CPU 100 calculates the packet loss of the near end using Formula (1) mentioned above.

The packet loss of the near end is a loss number of OAM packets in a transmission direction from the transmission device 2 to the transmission device 1. The CPU 100 calculates the packet loss of the near end using the TxFCI′ and RxFCI of the current time tc, and the TxFCI′ and RxFCI of the preceding time tp.

LSn={TxFCI′(tc)−TxFCI′(tp)}−{(RxFCI(tc)−RxFCI(tp)} (2)

The packet loss of the near end LSn is calculated using Formula (2) mentioned above. In this instance, TxFCI′ (tc) is the TxFCI′ of the current time tc. TxFCI′ (tp) is the TxFCI′ of the preceding time tp. RxFCI (tc) is the RxFCI of the current time tc. RxFCI (tp) is the RxFCI of the preceding time tp.

In the example of FIG. 3C, TxFCI′ (tc)=32, TxFCI′ (tp)=31, RxFCI (tc)=42 and RxFCI (tp)=41. Therefore, the LSn=(32−31)−(42−41)=0.

In this manner, in the transmission device 1, the CPU 100 calculates the packet loss of the near end LSn from a difference between the number of transmitted OAM packets of the line unit 21 of the other transmission device 2, and the received number of OAM packets of the line unit 11. In the other transmission device 2, since the RxFCI is not acquired in the manner mentioned above, the calculation of the packet loss of the far end is not performed.

An example of the LAG settings table 102b is illustrated in FIG. 3D. In the present example, the LAG settings table 102b of the transmission device 1 is illustrated. However, the LAG settings table 102b of the transmission device 2 also has the same configuration.

A combination of an identifier of the operation system line unit 11 and an identifier of the standby system line unit 12 are recorded in the LAG settings table 102b. In the present example, the identifier of the operation system line unit 11 is set to “#11”, and the identifier of the standby system line unit 12 is set to “#12”. For example, the LAG settings table 102b is set by the network management device 9.

When a failure of the operation system communication line 61 is detected as a result of a failure report from the operation system line unit 11, the CPU 100 identifies the standby system line unit 12, which corresponds to the operation system line unit 11 by referring to the LAG settings table 102b. Further, the CPU 100 initiates a transmitting and receiving process of packets to the standby system line unit 12 by setting the unit state information 31b of the standby system line unit 12 to the “operation system”. The CPU 100 stops a transmitting and receiving process of packets to the operation system line unit 11 by setting the unit state information 31b of the operation system line unit 11 to the “standby system”.

In other words, when a failure of the operation system communication line 61 is detected, the CPU 100 interchanges the operation system line unit 11 and the standby system line unit 12, which are registered in the LAG settings table 102b. In the other transmission device 2 also, when a failure of the operation system communication line 61 is detected as a result of a failure report from the operation system line unit 21, the CPU 100 interchanges the operation system line unit 21 and the standby system line unit 22, which are registered in the LAG settings table 102b. As a result of this, the transmitting and receiving of packets between the transmission devices 1 and 2 is continued by the standby system communication line 62.

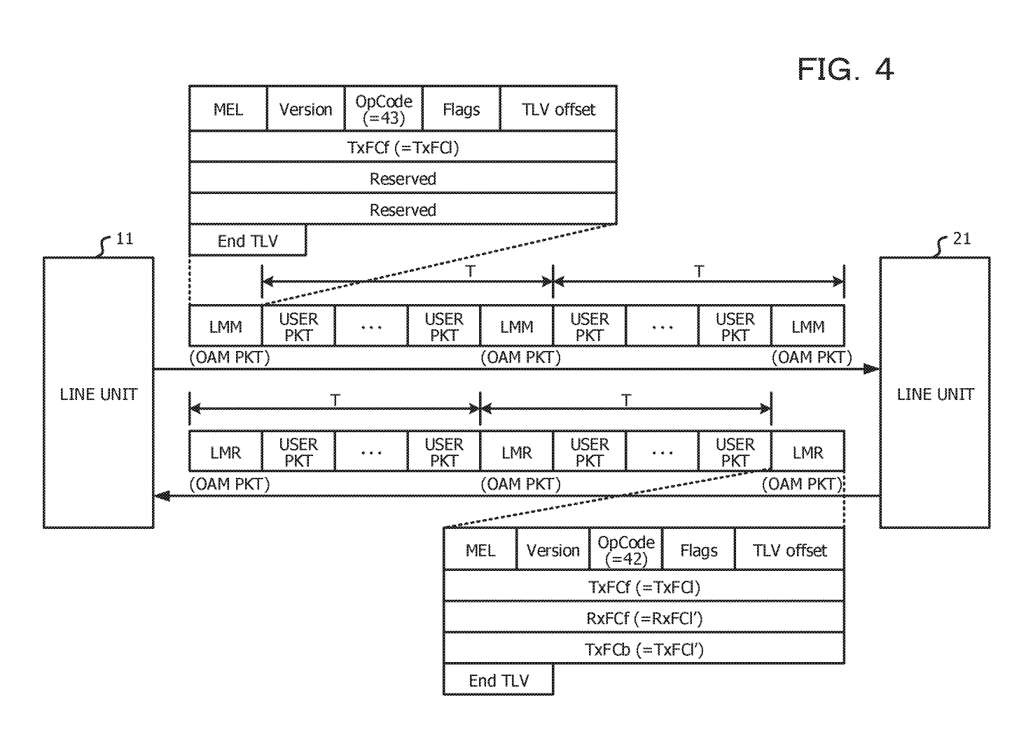

FIG. 4 is a configuration drawing that illustrates an example of packets that are sent and received between the line units 11 and 21. The operation system line unit 11 of the transmission device 1 transmits OAM packets (OAM PKT), which include loss measurement messages (LMMs), and user packets (user PKT) to the operation system line unit 21 of the other transmission device 2. The operation system line unit 21 of the transmission device 2 transmits OAM packets, which include loss measurement replies (LMRs), and user packets to the operation system line unit 11 of the other transmission device 1. The user packets and the OAM packets have Ethernet form configurations.

The LMMs and the LMRs are respectively packet loss measurement messages and loss measurement replies that are defined in recommendation Y.1731 of the ITU-T. More specifically, the transmission device 1 transmits OAM packets, which include LMMs, to the other transmission device 2. The transmission device 2 transmits OAM packets, which include LMRs, to the other transmission device 1 as replies to the LMMs. OAM packets, which include LMMs or LMRs are inserted between user packets at a fixed time interval T.

The LMMs include fields of “maintenance entity group level” (MEL), “Version”, “Opcode”, “Flags”, “TLV offset” (TLV: Type, Length, Value), “TxFCf”, “Reserved”, and “End TLV”. The “MEL” field indicates a level of a maintenance entity group of an OAM protocol data unit (PDU). The “Version” field indicates an OAM protocol version.

The “Opcode” field is an identifier of a message. In a case of an LMM, “43” is stored in the “Opcode” field. A fixed value of “0” is stored in the “Flags” field. A fixed value of “12” is stored in the “TLV offset” field. The TxFCI of the counter table 31a is stored in the “TxFCf” field. The “Reserved” field is an unused region. A fixed value of “0” is stored in the “End TLV” field.

The operation system line unit 11 of the transmission device 1 reports the TxFCI, which is the number of transmitted OAM packets that is counted by the transmission device 1, to the line unit 21 by transmitting OAM packets, which include LMMs, to the operation system line unit 21 of the other transmission device 2. The line unit 21 calculates a value of the packet loss of the near end from the reported TxFCI, and the RxFCI′, which is the received number of OAM packets that is counted by the transmission device 2 using Formula (1) mentioned above.

Meanwhile, the LMRs include fields of “MEL”, “Version”, “Opcode”, “Flags”, “TLV offset”, “TxFCf”, “RxFCf”, “TxFCb”, and “End TLV”. The LMRs are created based on the LMMs. Therefore, the same values as each value of the LMM is stored in the fields of “MEL”, “Version”, “Opcode”, “Flags”, “TLV offset”, “TxFCf”, and “End TLV”. The RxFCI′ of the counter table 31a is stored in the “RxFCf”, and the TxFCI′ of the counter table 31a is stored in the “TxFCb”.

The operation system line unit 21 of the transmission device 2 reports the TxFCI′ and the RxFCI′, which are the number of transmitted OAM packets and the number of received OAM packets that are counted by the transmission device 2, to the line unit 11 by transmitting OAM packets, which include LMRs, to the operation system line unit 11 of the other transmission device 1. The line unit 11 calculates a value of the packet loss of the far end LSf from the reported RxFCI′, and the TxFCI, which is the number of transmitted OAM packets that is counted by the transmission device 1 using Formula (1) mentioned above. The line unit 11 calculates a value of the packet loss of the near end LSn from the reported TxFCI′, and the RxFCI, which is the received number of OAM packets that is counted by the transmission device 1 using Formula (2) mentioned above.

In a case in which the operation system is switched from the communication line 61 to the communication line 62, in the same manner as the operation system line unit 11, the standby system line unit 12 of the transmission device 1 transmits OAM packets, which include LMMs, to the standby system line unit 22 of the other transmission device 2. In the same manner as the operation system line unit 21, the standby system line unit 22 of the transmission device 2 transmits OAM packets, which include LMRs, to the standby system line unit 12 of the other transmission device 1. Therefore, in this case also, the value of packet loss is calculated in the same manner as above.

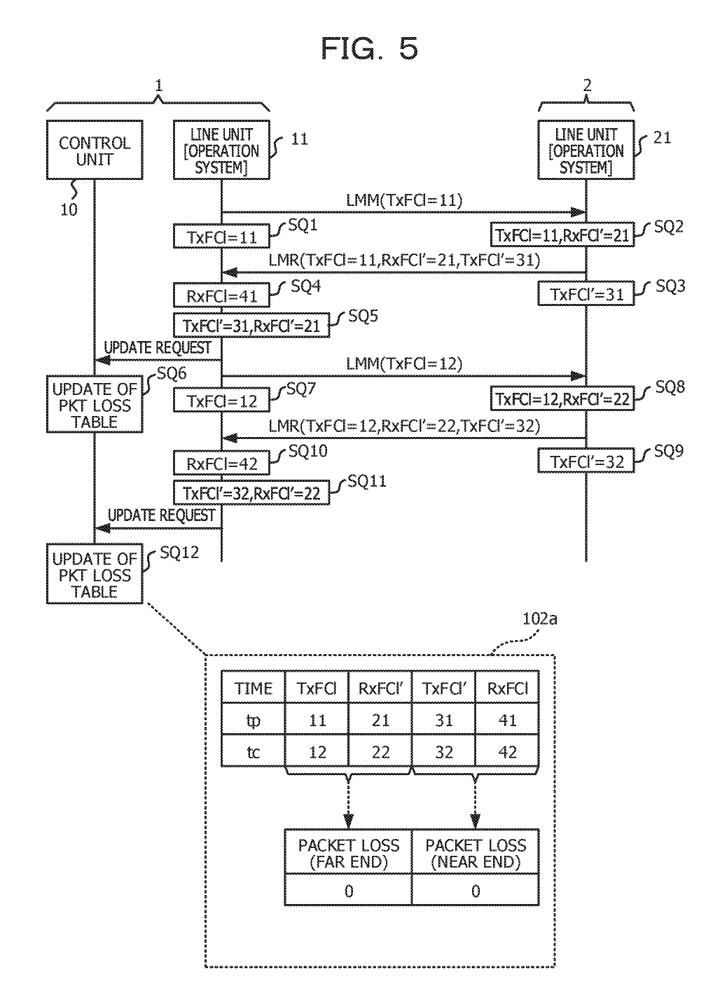

Next, a comparative example of the measurement of packet loss will be described. FIG. 5 is a sequence diagram that illustrates measurement actions of packet loss at a normal time in a comparative example.

In the comparative example, the respective synchronization of the numerical values in the counter tables 31a, is not performed between the operation system line unit 11 and the standby system line unit 12, and the operation system line unit 21 and the standby system line unit 22. At the initiation of a sequence of the present example, TxFCI=10, RxFCI=40, TxFCI′=30 and RxFCI′=20.

The operation system line unit 11 of the transmission device 1 transmits an LMM, which includes TxFCI=11, to the operation system line unit 21 of the other transmission device 2. After transmitting the LMM, the line unit 11 updates the TxFCI in the counter table 31a to 11 (refer to reference numeral SQ1).

When the LMM is received, the operation system line unit 21 of the transmission device 2 updates the TxFCI in the counter table 31a to 11 based on the TxFCI, which is included in the LMM, and updates the RxFCI′ to 21 (refer to reference numeral SQ2). The line unit 21 transmits an LMR, which includes TxFCI=11, RxFCI′=21 and TxFCI′=31, to the operation system line unit 11 of the other transmission device 1. After transmitting the LMR, the line unit 21 updates the TxFCI′ in the counter table 31a to 31 (refer to reference numeral SQ3).

When the LMR is received, the operation system line unit 11 of the transmission device 1 updates the RxFCI to 41 (refer to reference numeral SQ4). The line unit 11 respectively updates the TxFCI′ and the RxFCI′ in the counter table 31a to 31 and 21 based on the TxFCI′ and the RxFCI′, which are included in the LMR (refer to reference numeral SQ5).

Next, the line unit 11 requests an update of the PKT loss table 102a from the control unit 10. Each numerical value in the counter table 31a is included in the update request. When the update request is received, the control unit 10 updates the PKT loss table 102a based on the counter table 31a of the line unit 11 (refer to reference numeral SQ6).

As a result of this, TxFCI=10, RxFCI=40, TxFCI′=30, and RxFCI′=20 of the preceding time tp, and TxFCI=11, RxFCI=41, TxFCI′=31, and RxFCI′=21 of the current time tc, are recorded in the PKT loss table 102a.

Next, the operation system line unit 11 of the transmission device 1 transmits an LMM, which includes TxFCI=12, to the operation system line unit 21 of the other transmission device 2. After transmitting the LMM, the line unit 11 updates the TxFCI in the counter table 31a to 12 (refer to reference numeral SQ7).

When the LMM is received, the line unit 21 of the transmission device 2 updates the TxFCI in the counter table 31a to 12 based on the TxFCI, which is included in the LMM, and updates the RxFCI′ to 22 (refer to reference numeral SQ8). The line unit 21 transmits an LMR, which includes TxFCI=12, RxFCI′=22 and TxFCI′=32, to the operation system line unit 11 of the other transmission device 1. After transmitting the LMR, the line unit 21 updates the TxFCI′ in the counter table 31a to 32 (refer to reference numeral SQ9).

When the LMR is received, the operation system line unit 11 of the transmission device 1 updates the RxFCI to 42 (refer to reference numeral SQ10). The line unit 11 respectively updates the TxFCI′ and the RxFCI′ in the counter table 31a to 32 and 22 based on the TxFCI′ and the RxFCI′, which are included in the LMR (refer to reference numeral SQ11).

Next, the line unit 11 requests an update of the PKT loss table 102a from the control unit 10. When the update request is received, the control unit 10 updates the PKT loss table 102a based on the counter table 31a of the line unit 11 (refer to reference numeral SQ12).

As a result of this, TxFCI=11, RxFCI=41, TxFCI′=31, and RxFCI′=21 of the preceding time tp, and TxFCI=12, RxFCI=42, TxFCI′=32, and RxFCI′=22 of the current time tc, are recorded in the PKT loss table 102a. At this time, the values of packet loss LSf and LSn are 0 in the manner mentioned above with reference to FIG. 3C. The update process of the PKT loss table 102a of the transmission device 2 is omitted from FIG. 5, but is performed in the same manner as that of the transmission device 1.

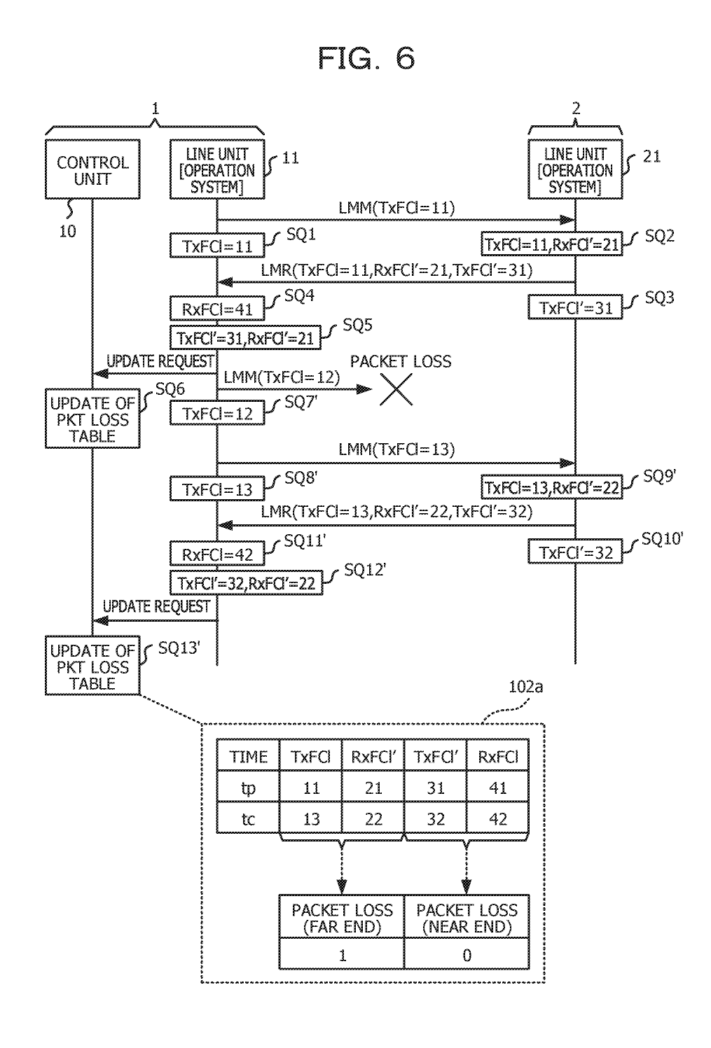

FIG. 6 is a sequence diagram that illustrates measurement actions of packet loss when packet loss occurs in a comparative example. In FIG. 6, the same reference numerals are applied to actions that are shared with FIG. 5, and description thereof is omitted.

After the update of the PKT loss table 102a (refer to reference numeral SQ6), the operation system line unit 11 of the transmission device 1 transmits an LMM, which includes TxFCI=12, to the operation system line unit 21 of the other transmission device 2. However, the LMM is not received by the standby system line unit 12 due to the occurrence of packet loss. After transmitting the LMM, the line unit 11 updates the TxFCI in the counter table 31a to 12 (refer to reference numeral SQ7′).

Next, the operation system line unit 11 of the transmission device 1 transmits an LMM, which includes TxFCI=13, to the operation system line unit 21 of the other transmission device 2. After transmitting the LMM, the line unit 11 updates the TxFCI in the counter table 31a to 13 (refer to reference numeral SQ8′).

When the LMM is received, the line unit 21 of the transmission device 2 updates the TxFCI in the counter table 31a to 13 based on the TxFCI, which is included in the LMM, and updates the RxFCI′ to 22 (refer to reference numeral SQ9′). The line unit 21 transmits an LMR, which includes TxFCI=13, RxFCI′=22 and TxFCI′=32, to the operation system line unit 11 of the other transmission device 1. After transmitting the LMR, the line unit 21 updates the TxFCI′ in the counter table 31a to 32 (refer to reference numeral SQ10′).

When the LMM is received, the operation system line unit 11 of the transmission device 1 updates the RxFCI to 42 (refer to reference numeral SQ11′). The line unit 11 respectively updates the TxFCI′ and the RxFCI′ in the counter table 31a to 32 and 22 based on the TxFCI′ and the RxFCI′, which are included in the LMR (refer to reference numeral SQ12′).

Next, the line unit 11 requests an update of the PKT loss table 102a from the control unit 10. When the update request is received, the control unit 10 updates the PKT loss table 102a based on the counter table 31a of the line unit 11 (refer to reference numeral SQ13′).

As a result of this, TxFCI=11, RxFCI=41, TxFCI′=31, and RxFCI′=21 of the preceding time tp, and TxFCI=13, RxFCI=42, TxFCI′=32, and RxFCI′=22 of the current time tc, are recorded in the PKT loss table 102a. At this time, the value of the packet loss of the far end is LSf=(13−11)−(22−21)=1 due to Formula (1) mentioned above. Therefore, the control units 10 and 20 of the transmission devices 1 and 2 detect that a packet loss of one has occurred. The value of the packet loss of the near end is LSn=(32−31)−(42−41)=0 due to Formula (2) mentioned above. The above-mentioned detection of packet loss is also performed in the same manner in the present embodiment.

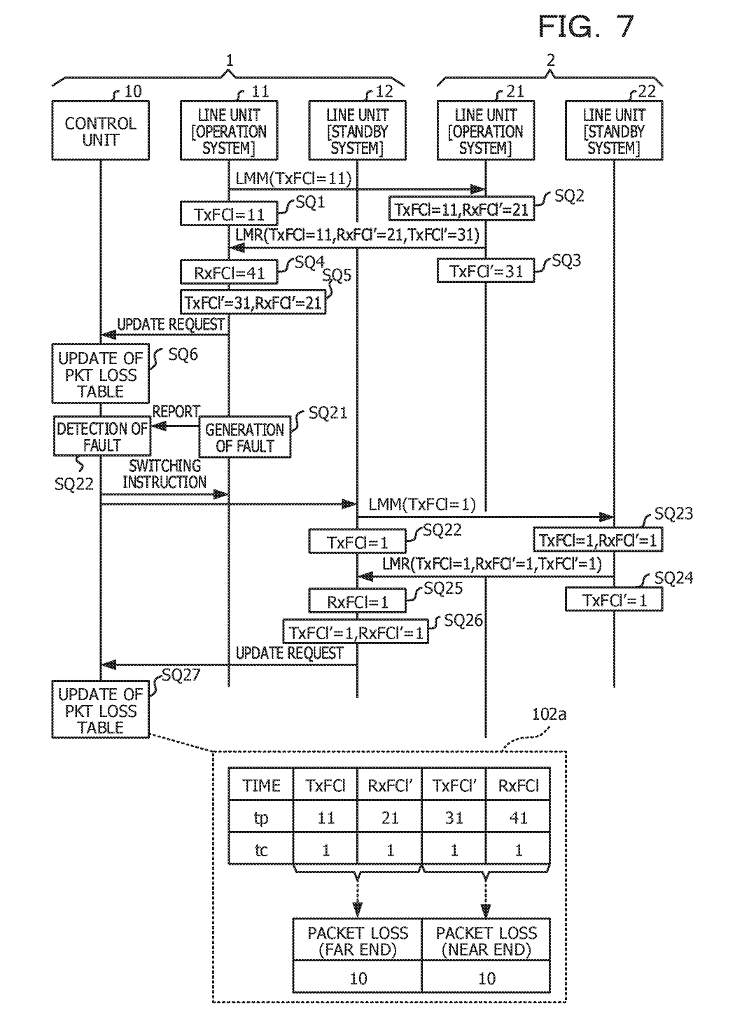

FIG. 7 is a sequence diagram that illustrates measurement actions of packet loss when failure occurs in a comparative example. In FIG. 7, the same reference numerals are applied to actions that are shared with FIG. 5, and description thereof is omitted.

When the fact that a failure has occurred in the communication line 61 is detected (refer to reference numeral SQ21), the operation system line unit 11 of the transmission device 1 reports the occurrence of a failure to the control unit 10. As a result of this, the control unit 10 detects the failure (refer to reference numeral SQ22).

Next, the control unit 10 transmits a switching instruction to the operation system line unit 11 and the standby system line unit 12. As a result of the switching instruction, the unit state information 31b of the operation system line unit 11 is changed to the “standby system”. The unit state information 31b of the standby system line unit 12 is changed to the “operation system”.

As a result of this, the operation system line unit 11 stops the transmitting and receiving process of packets. Further, the standby system line unit 12 initiates the transmitting and receiving process of packets. In the other transmission device 2, the operation system line unit 21 stops the transmitting and receiving process of packets. Further, the standby system line unit 22 initiates the transmitting and receiving process of packets.

At this time, TxFCI=0, RxFCI=0, TxFCI′=0 and RxFCI′=0 are stored as initial values in the counter table 31a of the standby system line unit 12 of the transmission device 1. TxFCI=0, TxFCI′=0 and RxFCI′=0 are stored as initial values in the counter table 31a of the standby system line unit 22 of the transmission device 2.

Next, the standby system line unit 12 of the transmission device 1 transmits an LMM, which includes TxFCI=1, to the standby system line unit 22 of the other transmission device 2. After transmitting the LMM, the line unit 12 updates the TxFCI in the counter table 31a to 1 (refer to reference numeral SQ22).

When the LMM is received, the line unit 22 of the transmission device 2 updates the TxFCI in the counter table 31a to 1 based on the TxFCI, which is included in the LMM, and updates the RxFCI′ to 1 (refer to reference numeral SQ23). The line unit 22 transmits an LMR, which includes TxFCI=1, RxFCI′=1 and TxFCI′=1, to the standby system line unit 12 of the other transmission device 1. After transmitting the LMR, the line unit 22 updates the TxFCI′ in the counter table 31a to 1 (refer to reference numeral SQ24).

When the LMR is received, the standby system line unit 12 of the transmission device 1 updates the RxFCI to 1 (refer to reference numeral SQ25). The line unit 12 updates the TxFCI′ and the RxFCI′ in the counter table 31a to 1 based on the TxFCI′ and the RxFCI′, which are included in the LMR (refer to reference numeral SQ26).

Next, the line unit 12 requests an update of the PKT loss table 102a from the control unit 10. When the update request is received, the control unit 10 updates the PKT loss table 102a based on the counter table 31a of the line unit 12 (refer to reference numeral SQ27).

As a result of this, TxFCI=11, RxFCI=41, TxFCI′=31, and RxFCI′=21 of the preceding time tp, and TxFCI=1, RxFCI=1, TxFCI′=1, and RxFCI′=1 of the current time tc, are recorded in the PKT loss table 102a. At this time, the value of the packet loss of the far end is LSf=(1−11)−(1−21)=10 due to Formula (1) mentioned above. Further, the value of the packet loss of the near end is LSn=(1−31)−(1−41)=10 due to Formula (2) mentioned above. In the other transmission device 2 also, the value of the packet loss of the near end (equivalent to the packet loss of the far end in the transmission device 1) is calculated in the same manner as that of the transmission device 1.

Therefore, the control units 10 and 20 of the transmission devices 1 and 2 erroneously detect that a packet loss of 10 has occurred regardless of the fact that packet loss has not occurred.

In this manner, in a case in which packets are sent and received by duplicated communication lines 61 and 62, if the communication line is switched as a result of the occurrence of a failure, the transmission devices 1 and 2 initiate the counting of the number of transmitted packets and the number of received packets afresh for the communication line 62 after switching. Therefore, since it is not possible for the transmission devices 1 and 2 to continue the measurement of packet loss based on the number of transmitted packets and the number of received packets, which are counted for the communication line 61 before switching, an error occurs in the measurement results.

Therefore, in the present embodiment, the number of transmitted packets and the number of received packets by the operation system communication line 61 is retained in association with the standby system communication line 62, and the retained number of transmitted packets and the retained number of received packets are set as initial values when the communication lines 61 and 62 are switched. As a result of this, it is possible to continue the measurement of packet loss even if the communication lines 61 and 62 are switched.

In other words, the line units 11 and 12 of the transmission device 1 report the number of OAM packets (TxFCI), which is sent to the other transmission device 2 by the transmission device 1 via the operation system communication line 61, to the other transmission device 2 at regular intervals, and retain the number of OAM packets in association with the standby system communication line 62. The line units 21 and 22 of the transmission device 2 report the number of OAM packets (RxFCI′), which is received from the other transmission device 1 by the transmission device 2 via the communication line 61, to the transmission device 1 at regular intervals, and retain the number of OAM packets in association with the communication line 62.

When the operation system is switched from the communication line 61 to the communication line 62, the standby system line unit 12 initiates counting of the number of OAM packets (TxFCI), which is transmitted to the other transmission device 2 by the transmission device 1 via the communication line 62, with the TxFCI, which is retained in association with the communication line 62 set as an initial value. The line unit 22 initiates counting of the packet number (RxFCI′), which is received from the other transmission device 1 by the transmission device 2 via the communication line 62, with the RxFCI′, which is retained in association with the communication line 62 set as an initial value.

In this manner, the line unit 11 of the transmission device 1 reports the TxFCI to the other transmission device 2 at regular intervals, and the line unit 21 of the transmission device 2 reports the RxFCI′ to the other transmission device 1 at regular intervals. Therefore, the transmission devices 1 and 2 can measure packet loss from the TxFCI and the RxFCI′.

When the operation system is switched from the communication line 61 to the communication line 62, the line units 12 and 22 respectively initiate counting of the TxFCI and the RxFCI′ for the communication line 62, with the TxFCI and the RxFCI′, which are retained in association with the communication line 62 set as initial values.

Accordingly, it is possible for the transmission devices 1 and 2 to continue the measurement of packet loss based on the TxFCI and the RxFCI′, which are counted for the operation system communication line 61. The same process is also performed for the TxFCI′ and the RxFCI. Hereinafter, the details of the actions of the transmission devices 1 and 2 of the present embodiment will be described.

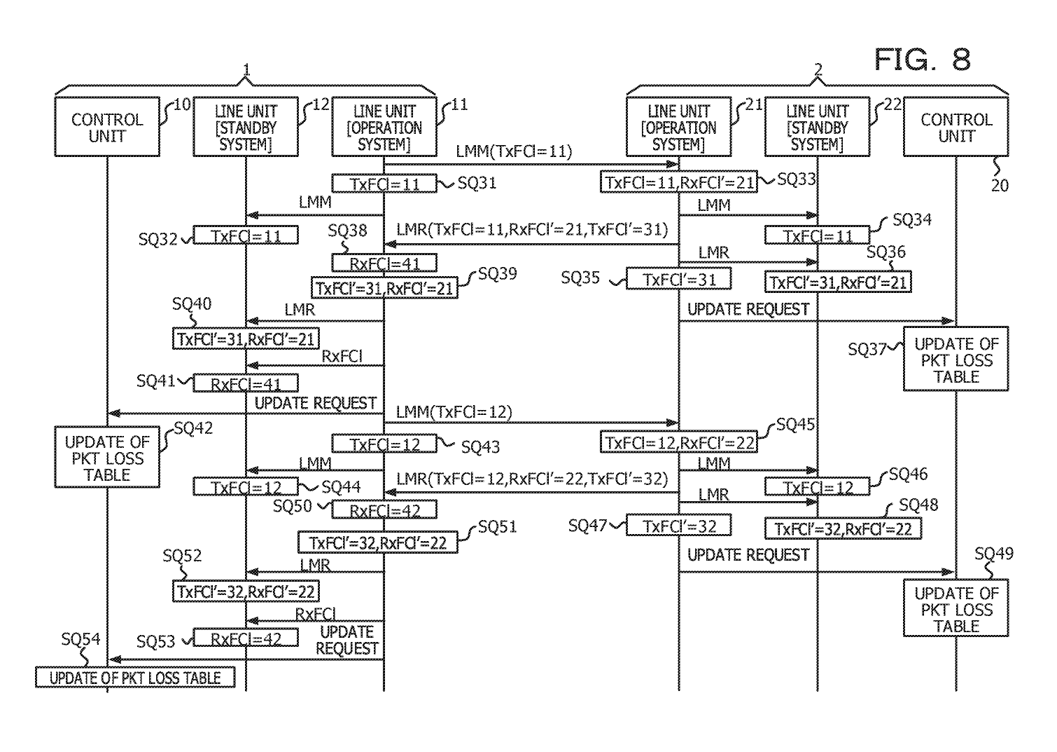

FIG. 8 is a sequence diagram that illustrates measurement actions of packet loss at a normal time in an embodiment. At the initiation of a sequence of the present example, TxFCI=10, RxFCI=40, TxFCI′=30 and RxFCI′=20.

The operation system line unit 11 of the transmission device 1 transmits an LMM, which includes TxFCI=11, to the operation system line unit 21 of the other transmission device 2. After transmitting the LMM, the line unit 11 updates the TxFCI in the counter table 31a to 11 (refer to reference numeral SQ31).

Next, the line unit 11 transmits an LMM, which includes TxFCI=11, to the standby system line unit 12 via the switching unit 14. When the LMM is received, the line unit 12 updates the TxFCI in the counter table 31a to 11 to match the TxFCI, which is included in the LMM (refer to reference numeral SQ32).

In this manner, the line units 11 and 12 report the packet number (TxFCI), which is sent to the other transmission device 2 by the transmission device 1 via the operation system communication line 61, to the other transmission device 2 at regular intervals, and retain the packet number in association with the standby system communication line 62.

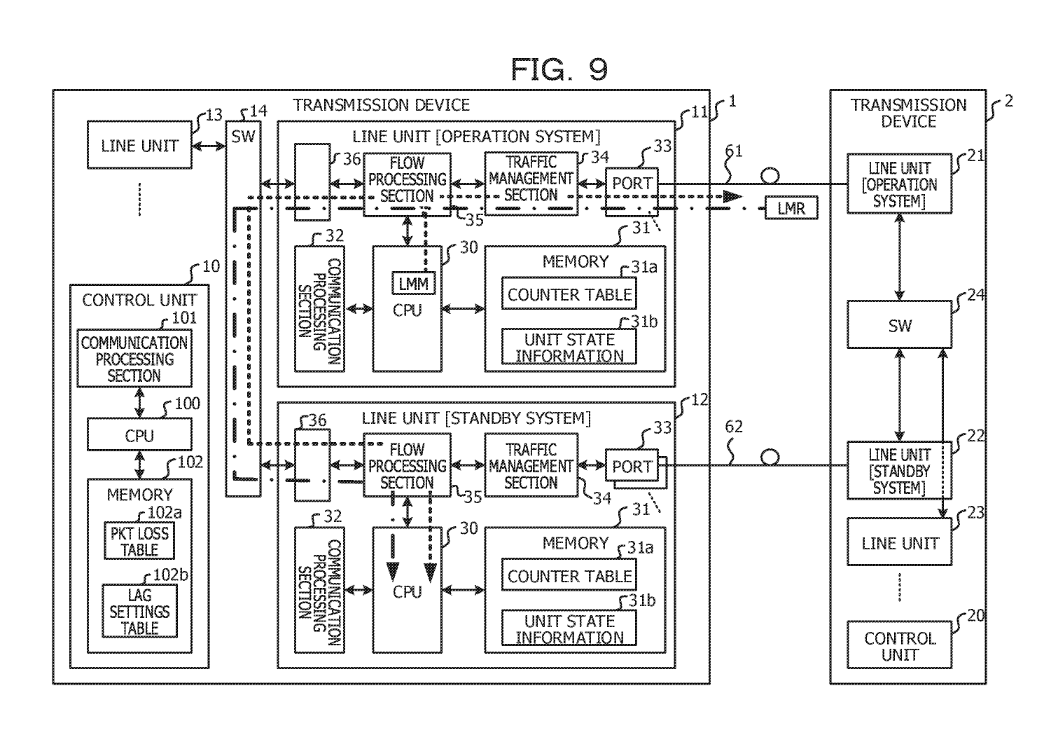

A pathway of OAM packets in the transmission device 1 is illustrated in FIG. 9. Hereinafter, a pathway (refer to the dotted line) of an OAM packet, which includes an LMM, will be described.

In the operation system line unit 11, the CPU 30 creates an OAM packet, which includes an LMM, and outputs the OAM packet to the flow processing section 35. The flow processing section 35 respectively outputs the OAM packet to the traffic management section 34 and the SW-IF section 36.

The OAM packet, which is input to the traffic management section 34, is sent to the operation system line unit 21 of the other transmission device 2 via the port 33. Meanwhile, the OAM packet, which is input to the SW-IF section 36, is sent to the standby system line unit 12 via the switching unit 14.

In the standby system line unit 12, the OAM packet is input to the CPU 30 through the SW-IF section 36 and the flow processing section 35. The CPU 30 acquires the TxFCI from the OAM packet. Further, the CPU 30 updates the TxFCI in the counter table 31a based on the acquired TxFCI.

In this manner, the operation system line unit 11 transmits the TxFCI to the standby system line unit 12 by including the TxFCI in an OAM packet. The standby system line unit 12 updates the TxFCI in the counter table 31a to match the TxFCI, which is included in the received OAM packet. Accordingly, the standby system line unit 12 can easily update the TxFCI by performing the same process as the other packet process.

Referring to FIG. 8 again, when the LMM is received, the operation system line unit 21 of the transmission device 2 updates the TxFCI in the counter table 31a to 11 based on the TxFCI, which is included in the LMM, and updates the RxFCI′ to 21 (refer to reference numeral SQ33). Next, the line unit 21 transfers the OAM packet, which includes the LMM, to the standby system line unit 22.

The standby system line unit 22 updates the TxFCI in the counter table 31a to 11 to match the TxFCI, which is included in the transferred OAM packet (refer to reference numeral SQ34).

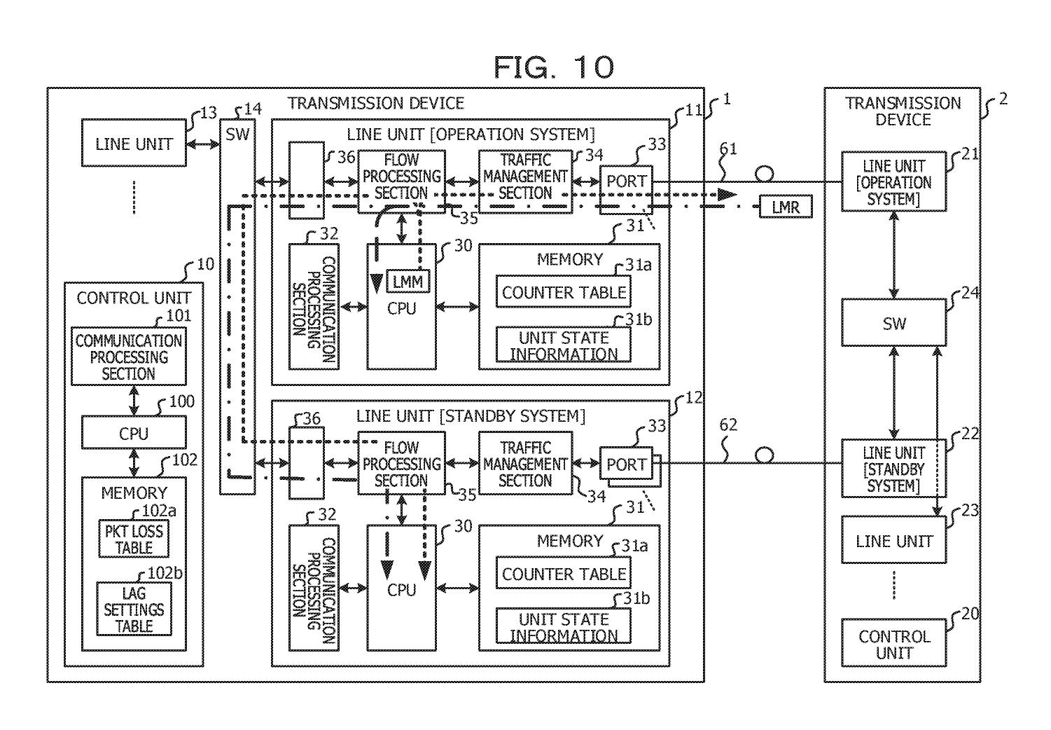

A pathway of an OAM packet in the other transmission device 2 is illustrated in FIG. 10. Hereinafter, a pathway (refer to the dashed-dotted line) of an OAM packet, which includes an LMM, will be described.

When an OAM packet, which includes an LMM, is received by the transmission device 2, the OAM packet is input to the flow processing section 35 through the port 33 and the traffic management section 34. The flow processing section 35 outputs the input OAM packet to the CPU 30 and the SW-IF section 36.

The CPU 30 acquires the TxFCI from the OAM packet, and updates the TxFCI in the counter table 31a based on the acquired TxFCI.

Meanwhile, the OAM packet, which is input to the SW-IF section 36, is sent to the standby system line unit 22 via the switching unit 24.

In the standby system line unit 22, the OAM packet is input to the CPU 30 through the SW-IF section 36 and the flow processing section 35. The CPU 30 acquires the TxFCI from the OAM packet, and updates the TxFCI in the counter table 31a based on the acquired TxFCI.

In this manner, the operation system line unit 21 acquires the TxFCI from the OAM packet, which is received from the operation system line unit 11 of the other transmission device 1, and transfers the OAM packet to the standby system line unit 22. The standby system line unit 22 acquires the TxFCI from the OAM packet, which is transferred from the operation system line unit 21. Accordingly, the standby system line unit 22 can easily acquire the TxFCI by performing the same process as the other packet process.

Referring to FIG. 8 again, the line unit 21 transmits an LMR, which includes TxFCI=11, RxFCI′=21 and TxFCI′=31, to the operation system line unit 11 of the other transmission device 1. The line unit 21 transmits the same LMR as the sent LMR to the standby system line unit 22. After transmitting the LMR, the line unit 21 updates the TxFCI′ in the counter table 31a to 31 (refer to reference numeral SQ35).

The standby system line unit 22 respectively updates the TxFCI′ and the RxFCI′ in the counter table 31a to 31 and 21 to match the TxFCI′ and the RxFCI′, which are included in the LMR, which is received from the operation system line unit 21 receives (refer to reference numeral SQ36).

In this manner, the line units 21 and 22 report the packet number (RxFCI′), which is received from the other transmission device 2 by the transmission device 2 via the communication line 61, to the transmission device 1 at regular intervals, and retain the packet number in association with the communication line 62.

A pathway of an OAM packet, which includes an LMR, is illustrated in FIG. 10 by the dotted line. In the operation system line unit 21, the CPU 30 creates an OAM packet, which includes an LMR, and outputs the OAM packet to the flow processing section 35. The flow processing section 35 respectively outputs the OAM packet to the traffic management section 34 and the SW-IF section 36.

The OAM packet, which is input to the traffic management section 34, is sent to the operation system line unit 11 of the other transmission device 1 via the port 33. Meanwhile, the OAM packet, which is input to the SW-IF section 36, is sent to the standby system line unit 22 via the switching unit 24.

In the standby system line unit 22, the OAM packet is input to the CPU 30 through the SW-IF section 36 and the flow processing section 35. The CPU 30 acquires the TxFCI′ and the RxFCI′ from the OAM packet, and updates the TxFCI′ and the RxFCI′ in the counter table 31a based on the acquired TxFCI′ and RxFCI′.

In this manner, the operation system line unit 21 transmits the TxFCI′ and the RxFCI′ to the standby system line unit 22 by including the TxFCI′ and the RxFCI′ in an OAM packet. The standby system line unit 22 respectively updates the TxFCI′ and the RxFCI′ in the counter table 31a to match the TxFCI′ and the RxFCI′, which are included in the received OAM packet. Accordingly, the standby system line unit 22 can easily update the TxFCI′ and the RxFCI′ by performing the same process as the other packet process.

Referring to FIG. 8 again, the line unit 21 requests an update of the PKT loss table 102a from the control unit 20. Each numerical value in the counter table 31a is included in the update request. When the update request is received, the control unit 20 updates the PKT loss table 102a based on the counter table 31a of the line unit 21 (refer to reference numeral SQ37).

As a result of this, TxFCI=10, TxFCI′=30, and RxFCI′=20 of the preceding time tp, and TxFCI=11, TxFCI′=31, and RxFCI′=21 of the current time tc, are recorded in the PKT loss table 102a of the control unit 20 of the transmission device 2.

When the LMR is received, the operation system line unit 11 of the transmission device 1 updates the RxFCI to 41 (refer to reference numeral SQ38). The line unit 11 respectively updates the TxFCI′ and the RxFCI′ in the counter table 31a to 31 and 21 based on the TxFCI′ and the RxFCI′, which are included in the LMR (refer to reference numeral SQ39).

Next, the line unit 11 transfers the received LMR to the standby system line unit 12. The standby system line unit 12 respectively updates the TxFCI′ and the RxFCI′ in the counter table 31a to 31 and 21 to match the TxFCI′ and the RxFCI′, which are included in the transferred LMR (refer to reference numeral SQ40).

A pathway of an OAM packet, which includes an LMR, is illustrated by a dashed-dotted line in FIG. 9. When an OAM packet, which includes an LMR, is received by the transmission device 1, the OAM packet is input to the flow processing section 35 through the port 33 and the traffic management section 34. The flow processing section 35 outputs the input OAM packet to the CPU 30 and the SW-IF section 36.

The CPU 30 acquires the TxFCI′ and the RxFCI′ from the OAM packet. Further, the CPU 30 respectively updates the TxFCI′ and the RxFCI′ in the counter table 31a based on the acquired TxFCI′ and the RxFCI′.

Meanwhile, the OAM packet, which is input to the SW-IF section 36, is sent to the standby system line unit 12 via the switching unit 14.

In the standby system line unit 12, the OAM packet is input to the CPU 30 through the SW-IF section 36 and the flow processing section 35. The CPU 30 acquires the TxFCI′ and the RxFCI′ from the OAM packet, and respectively updates the TxFCI′ and the RxFCI′ in the counter table 31a based on the acquired TxFCI′ and RxFCI′.

In this manner, the operation system line unit 11 acquires the TxFCI′ and the RxFCI′ from the OAM packet, which is received from the operation system line unit 21 of the other transmission device 2, and transfers the OAM packet to the standby system line unit 12. The standby system line unit 12 acquires the TxFCI′ and the RxFCI′ from the OAM packet, which is transferred from the operation system line unit 11. Accordingly, the standby system line unit 12 can easily acquire the TxFCI′ and the RxFCI′ by performing the same process as the other packet process.

Referring to FIG. 8 again, the line unit 11 transmits the RxFCI to the standby system line unit 12. At this time, the line unit 11 may transmit the RxFCI by including the RxFCI in an OAM packet in the same manner as the TxFCI and the like. The standby system line unit 12 updates the RxFCI in the counter table 31a to 41 to match the RxFCI, which is received from the operation system line unit 11 (refer to reference numeral SQ41).

Next, the line unit 11 requests an update of the PKT loss table 102a from the control unit 10. Each numerical value in the counter table 31a is included in the update request, and when the update request is received, the control unit 10 updates the PKT loss table 102a based on the counter table 31a of the line unit 11 (refer to reference numeral SQ42).

As a result of this, TxFCI=10, RxFCI=40, TxFCI′=30, and RxFCI′=20 of the preceding time tp, and TxFCI=11, RxFCI=41, TxFCI′=31, and RxFCI′=21 of the current time tc, are recorded in the PKT loss table 102a of the control unit 10 of the transmission device 1.

Next, the operation system line unit 11 of the transmission device 1 transmits an LMM, which includes TxFCI=12, to the operation system line unit 21 of the other transmission device 2. After transmitting the LMM, the line unit 11 updates the TxFCI in the counter table 31a to 12 (refer to reference numeral SQ43).

Next, the line unit 11 transmits an LMM, which includes TxFCI=12, to the standby system line unit 12 via the switching unit 14. When the LMM is received, the line unit 12 updates the TxFCI in the counter table 31a to 12 to match the TxFCI, which is included in the LMM (refer to reference numeral SQ44).

When the LMM is received, the operation system line unit 21 of the transmission device 2 updates the TxFCI in the counter table 31a to 12 based on the TxFCI, which is included in the LMM, and updates the RxFCI′ to 22 (refer to reference numeral SQ45). Next, the line unit 21 transfers the OAM packet, which includes the LMM, to the standby system line unit 22.

The standby system line unit 22 updates the TxFCI in the counter table 31a to 12 to match the TxFCI, which is included in the transferred OAM packet (refer to reference numeral SQ46).

Next, the line unit 21 transmits an LMR, which includes TxFCI=12, RxFCI′=22 and TxFCI′=32, to the operation system line unit 11 of the other transmission device 1. The line unit 21 transmits the same LMR as the sent LMR to the standby system line unit 22. After transmitting the LMR, the line unit 21 updates the TxFCI′ in the counter table 31a to 32 (refer to reference numeral SQ47).

The standby system line unit 22 respectively updates the TxFCI′ and the RxFCI′ in the counter table 31a to 32 and 22 to match the TxFCI′ and the RxFCI′, which are included in the LMR, which is received from the operation system line unit 21 receives (refer to reference numeral SQ48).

Next, the line unit 21 requests an update of the PKT loss table 102a from the control unit 20. When the update request is received, the control unit 20 updates the PKT loss table 102a based on the counter table 31a of the line unit 21 (refer to reference numeral SQ49).

As a result of this, TxFCI=11, TxFCI′=31, and RxFCI′=21 of the preceding time tp, and TxFCI=12, TxFCI′=32, and RxFCI′=22 of the current time tc, are recorded in the PKT loss table 102a of the control unit 20 of the transmission device 2. Accordingly, the control unit 20 calculates the value of packet loss=0 using Formula (1) mentioned above.

When the LMR is received, the operation system line unit 11 of the transmission device 1 updates the RxFCI to 42 (refer to reference numeral SQ50). The line unit 11 respectively updates the TxFCI′ and the RxFCI′ in the counter table 31a to 32 and 22 based on the TxFCI′ and the RxFCI′, which are included in the LMR (refer to reference numeral SQ51).

Next, the line unit 11 transfers the received LMR to the standby system line unit 12. The standby system line unit 12 respectively updates the TxFCI′ and the RxFCI′ in the counter table 31a to 32 and 22 to match the TxFCI′ and the RxFCI′, which are included in the transferred LMR (refer to reference numeral SQ52).

Next, the line unit 11 transmits the RxFCI to the standby system line unit 12. At this time, the line unit 11 may transmit the RxFCI by including the RxFCI in an OAM packet in the same manner as the TxFCI and the like. The standby system line unit 12 updates the RxFCI in the counter table 31a to 42 to match the RxFCI, which is received from the operation system line unit 11 (refer to reference numeral SQ53).

Next, the line unit 11 requests an update of the PKT loss table 102a from the control unit 10. When the update request is received, the control unit 10 updates the PKT loss table 102a based on the counter table 31a of the line unit 11 (refer to reference numeral SQ54).

As a result of this, TxFCI=11, RxFCI=41, TxFCI′=31, and RxFCI′=21 of the preceding time tp, and TxFCI=12, RxFCI=42, TxFCI′=32, and RxFCI′=22 of the current time tc, are recorded in the PKT loss table 102a of the control unit 10 of the transmission device 1. Accordingly, the control unit 10 calculates the value of packet loss of the far end LSf=0 using Formula (1) mentioned above, and calculates the value of packet loss of the near end LSn=0 using Formula (2) mentioned above.

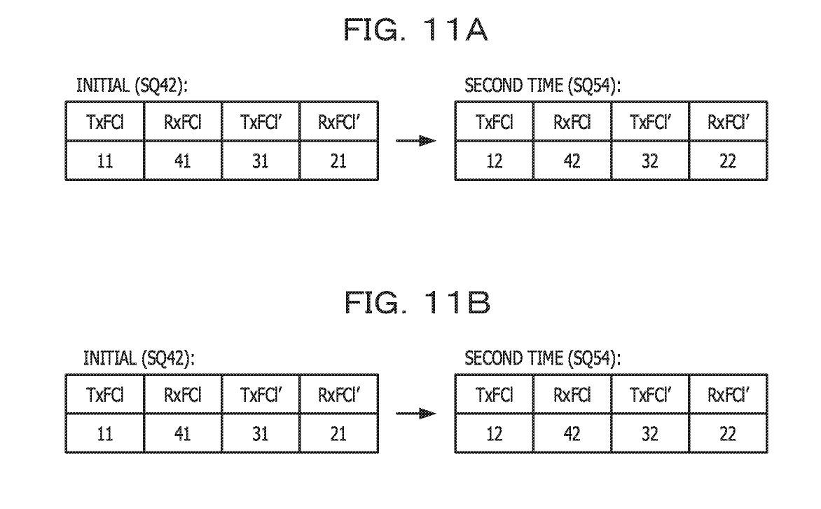

A change in the counter table 31a of the operation system line unit 11 in the sequence of FIG. 8 is illustrated in FIG. 11A. A change in the counter table 31a of the standby system line unit 12 in the sequence of FIG. 8 is illustrated in FIG. 11B.

In the abovementioned manner, the operation system line unit 11 transmits the LMM, the LMR and the RxFCI to the standby system line unit 12. Therefore, at an initial update time of the PKT loss table 102a (refer to reference numeral SQ42) and a second update time of the PKT loss table 102a (refer to reference numeral SQ54), the TxFCI, the RxFCI, the TxFCI′ and the RxFCI′ coincide with one another between the operation system line unit 11 and the standby system line unit 12. The PKT loss table 102a after the second update attains the state that is illustrated in FIG. 3C.

In this manner, the TxFCI, the RxFCI, the TxFCI′, and the RxFCI′ are synchronized between the operation system line unit 11 and the standby system line unit 12. The same applies to the counter tables 31a of the operation system line unit 21 and the standby system line unit 22 of the other transmission device 2. Accordingly, in the manner to be mentioned below, each transmission device 1 and 2 can continue the measurement of packet loss even if the communication line is switched.

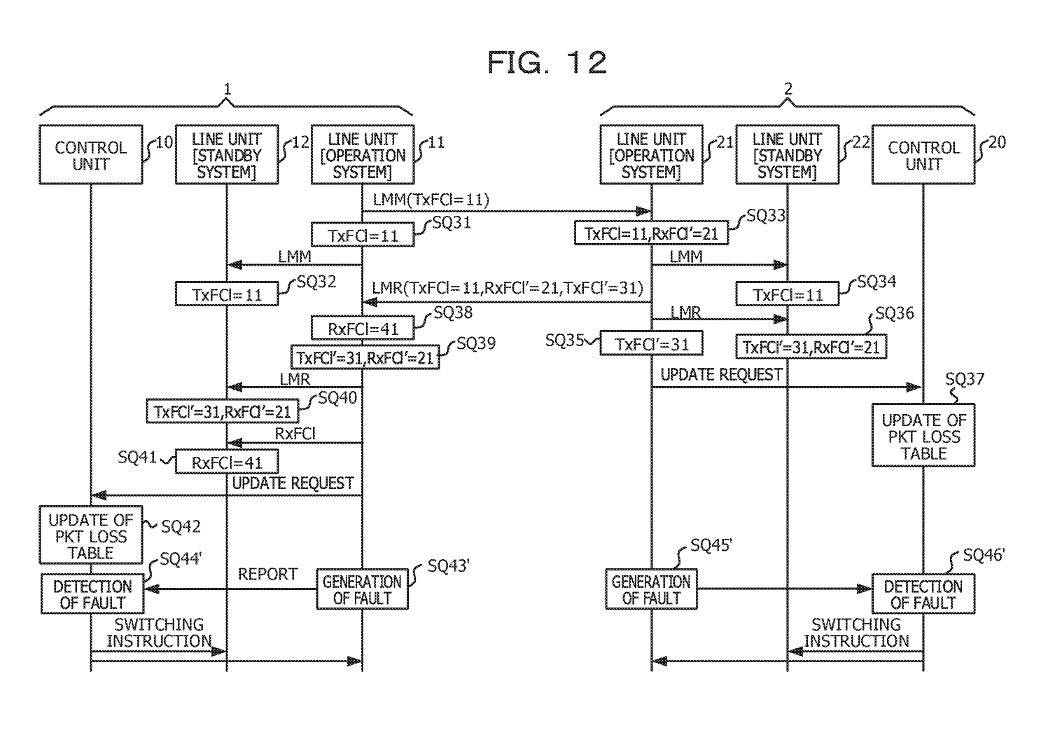

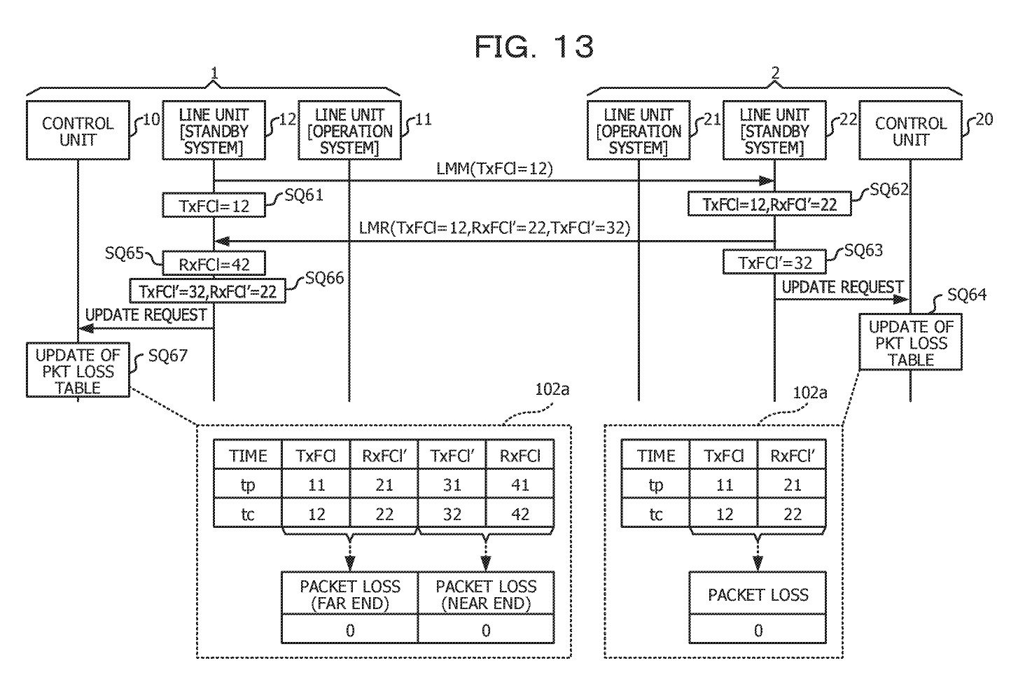

FIG. 12 and FIG. 13 are sequence diagrams that illustrate measurement actions of packet loss when failure occurs in the embodiment. Firstly, description will be given from FIG. 12 and subsequently description of FIG. 13 will be given. In FIG. 12, the same reference numerals are applied to processes that are shared with FIG. 8, and description thereof is omitted.

As was mentioned with reference to FIG. 8, before the operation system is switched from the communication line 61 to the communication line 62, the standby system line unit 12 retains the TxFCI in association with the communication line 62 by updating the TxFCI, which is counted by the standby system line unit 12, to match the TxFCI, which is counted by the operation system line unit 11. The standby system line unit 22 retains the RxFCI′ in association with the communication line 62 by updating the RxFCI′, which is counted by the standby system line unit 22, to match the RxFCI′, which is counted by the operation system line unit 21.

Therefore, the standby system line unit 12 of the transmission device 1 can retain the TxFCI by making the TxFCI coincide with the operation system line unit 11. The standby system line unit 22 of the transmission device 2 can retain the RxFCI′ by making the RxFCI′ coincide with the operation system line unit 21. Accordingly, in the following manner, the transmission devices 1 and 2 can reliably perform the measurement of packet loss even after the operation system is switched from the communication line 61 to the communication line 62.

Firstly, referring to FIG. 12, in the transmission device 1, when the operation system line unit 11 detects the fact that a failure has occurred in the operation system communication line 61 (refer to reference numeral SQ43′) after the initial update of the PKT loss table 102a (refer to reference numeral SQ42), the occurrence of a failure is reported to the control unit 10. As a result of this, the control unit 10 detects the failure (refer to reference numeral SQ44′).

Next, the control unit 10 transmits a switching instruction to the operation system line unit 11 and the standby system line unit 12. As a result of the switching instruction, the unit state information 31b of the operation system line unit 11 is changed to the “standby system”, and the unit state information 31b of the standby system line unit 12 is changed to the “operation system”.

Meanwhile, in the transmission device 2 also, when the operation system line unit 21 detects the fact that a failure has occurred in the operation system communication line 61 (refer to reference numeral SQ45′) after the initial update of the PKT loss table 102a (refer to reference numeral SQ37), the occurrence of a failure is reported to the control unit 20. As a result of this, the control unit 20 detects the failure (refer to reference numeral SQ46′).

Next, the control unit 20 transmits a switching instruction to the operation system line unit 21 and the standby system line unit 22. As a result of the switching instruction, the unit state information 31b of the operation system line unit 21 is changed to the “standby system”, and the unit state information 31b of the standby system line unit 22 is changed to the “operation system”.

Next, referring to FIG. 13, after switching of the communication lines 61 and 62, the standby system line unit 12 of the transmission device 1 transmits an LMM, which includes TxFCI=12, to the operation system line unit 22 of the other transmission device 2. After transmitting the LMM, the line unit 21 updates the TxFCI in the counter table 31a to 12 (refer to reference numeral SQ61). In this manner, the standby system line unit 12 initiates counting of the packet number (TxFCI), which is sent to the other transmission device 2 by the transmission device 1 via the communication line 62, with the TxFCI, which is retained in association with the communication line 62 set as an initial value.

When the LMM is received, the standby system line unit 22 of the transmission device 2 updates the TxFCI in the counter table 31a to 12 based on the TxFCI, which is included in the LMM, and updates the RxFCI′ to 22 (refer to reference numeral SQ62).

Next, the line unit 22 transmits an LMR, which includes TxFCI=12, RxFCI′=22 and TxFCI′=32, to the standby system line unit 12 of the other transmission device 1. After transmitting the LMR, the line unit 22 updates the TxFCI′ in the counter table 31a to 32 (refer to reference numeral SQ63). In this manner, the standby system line unit 22 initiates counting of the packet number (RxFCI′), which is received from the other transmission device 1 by the transmission device 2 via the communication line 62, with the RxFCI′, which is retained in association with the communication line 62 set as an initial value.

Next, the line unit 22 requests an update of the PKT loss table 102a from the control unit 20. When the update request is received, the control unit 20 updates the PKT loss table 102a based on the counter table 31a of the line unit 22 (refer to reference numeral SQ64).

As a result of this, TxFCI=11 and RxFCI′=21 of the preceding time tp, and TxFCI=12 and RxFCI′=22 of the current time tc, are recorded in the PKT loss table 102a of the control unit 20 of the transmission device 2. The control unit 20 calculates the value of packet loss=0 from each numerical value based on Formula (1) mentioned above.

Accordingly, even if the communication lines 61 and 62 are switched, it is possible for the transmission device 2 to continue the measurement of packet loss based on the number of transmitted OAM packets and the number of received OAM packets, which are counted for the communication line 61 before the switch.

Meanwhile, when the LMR is received, the standby system line unit 12 of the transmission device 1 updates the RxFCI to 42 (refer to reference numeral SQ65). The line unit 12 respectively updates the TxFCI′ and the RxFCI′ in the counter table 31a to 32 and 22 based on the TxFCI′ and the RxFCI′, which are included in the LMR (refer to reference numeral SQ66).

Next, the line unit 12 requests an update of the PKT loss table 102a from the control unit 10. When the update request is received, the control unit 10 updates the PKT loss table 102a based on the counter table 31a of the line unit 12 (refer to reference numeral SQ67).

As a result of this, TxFCI=11, RxFCI=41, TxFCI′=31, and RxFCI′=21 of the preceding time tp, and TxFCI=12, RxFCI=42, TxFCI′=32, and RxFCI′=22 of the current time tc, are recorded in the PKT loss table 102a of the control unit 10 of the transmission device 1. Accordingly, the control unit 10 calculates the value of packet loss of the far end LSf=0 using Formula (1) mentioned above, and calculates the value of packet loss of the near end LSn=0 using Formula (2) mentioned above.

Accordingly, even if the operation system is switched from the communication line 61 to the communication line 62, it is possible for the transmission device 1 to continue the measurement of packet loss based on the number of transmitted OAM packets and the number of received OAM packets, which are counted for the communication line 61 before the switch.

In the manner described above, the transmission system according to the present embodiment is a transmission system that forms a logical path for transmitting packets by logically controlling the communication line 61 and the communication line 62, which are provided between the transmission devices 1 and 2, and includes the line units 11, 12, 21 and 22. The line units 11 and 12 report the packet number (TxFCI), which the transmission device 1 transmits to the other transmission device 2 via the operation system communication line 61, from the transmission device 1 to the other transmission device 2 at regular intervals, and retain the packet number in association with the standby system communication line 62. The line units 21 and 22 report the packet number (RxFCI′), which the transmission device 2 receives from the other transmission device 1 via the communication line 61, from the transmission device 2 to the other transmission device 1 at regular intervals, and retain the packet number in association with the communication line 61.

When the operation system is switched from the communication line 61 to the communication line 62, the line unit 11 initiates counting of the packet number, which is sent to the transmission device 2 by the transmission device 1 via the communication line 62, with the packet number, which is retained in association with the communication line 62 set as an initial value. The line unit 21 initiates counting of the packet number, which is received from the transmission device 1 by the transmission device 2 via the communication line 62, with the packet number, which is retained in association with the communication line 62 set as an initial value.

According to the above-mentioned configuration, the line unit 11 of the transmission device 1 reports the TxFCI to the other transmission device 2 at regular intervals, and the line unit 21 of the transmission device 2 reports the RxFCI′ to the other transmission device 1 at regular intervals. Therefore, the transmission devices 1 and 2 can measure packet loss from the TxFCI and the RxFCI′.

When the operation system is switched from the communication line 61 to the communication line 62, the line units 12 and 22 respectively initiate counting of the TxFCI and the RxFCI′ for the communication line 62, with the TxFCI and the RxFCI′, which are retained in association with the communication line 62 set as initial values.

Accordingly, even if the operation system is switched from the communication line 61 to the communication line 62, it is possible for the transmission devices 1 and 2 to continue the measurement of packet loss based on the TxFCI and the RxFCI′, which are counted for the communication line 61 before switching.

The transmission device 1 according to the embodiment is a transmission device in which a logical path for transmitting packets by logically controlling the communication line 61 and the communication line 62, which are provided between the other transmission device 2, is formed. The line units 11 and 12 report the packet number (TxFCI), which is sent to the other transmission device 2 via the operation system communication line 61, to the other transmission device 2 at regular intervals, and retain the packet number in association with the standby system communication line 62. When the operation system is switched from the communication line 61 to the communication line 62, the line unit 12 initiates counting of the packet number, which is sent to the transmission device 2 via the communication line 62, with the packet number, which is retained in association with the communication line 62 set as an initial value.

According to the above-mentioned configuration, the line unit 11 of the transmission device 1 reports the TxFCI to the other transmission device 2 at regular intervals. Therefore, the other transmission device 2 can measure packet loss from the TxFCI and the packet received number of the other transmission device 2 (RxFCI′).

When the operation system is switched from the communication line 61 to the communication line 62, the line unit 12 initiates counting of the TxFCI for the communication line 62, with the TxFCI, which is retained in association with the communication line 62 set as an initial value.

Accordingly, even if the operation system is switched from the communication line 61 to the communication line 62, it is possible for the transmission device 2 to continue the measurement of packet loss based on the TxFCI, which is counted for the communication line 61 before switching.

The transmission device 2 according to another embodiment is a transmission device in which a logical path for transmitting packets by logically controlling the communication line 61 and the communication line 62, which are provided between the other transmission device 1, is formed. The line units 21 and 22 report the packet number (RxFCI′), which is received from the other transmission device 1 via the operation system communication line 61, to the other transmission device 1 at regular intervals, and retain the packet number in association with the second standby system communication line. When the operation system is switched from the communication line 61 to the communication line 62, the line units 21 and 22 initiate counting of the packet number, which is received from the other transmission device 1 via the communication line 62, with the packet number, which is retained in association with the communication line 62 set as an initial value.

According to the above-mentioned configuration, the line unit 21 of the transmission device 2 reports the RxFCI′ to the other transmission device 1 at regular intervals. Therefore, the other transmission device 1 can measure packet loss using the number of transmitted packets (TxFCI) of the transmission device 1 and the RxFCI′.

When the operation system is switched from the communication line 61 to the communication line 62, the line unit 22 initiates counting of the RxFCI′ for the communication line 62, with the RxFCI′, which is retained in association with the communication line 62 set as an initial value.

Accordingly, even if the operation system is switched from the communication line 61 to the communication line 62, it is possible for the transmission device 1 to continue the measurement of packet loss based on the RxFCI′, which is counted for the communication line 61 before switching.

The transmission method according to the present embodiment is a transmission method that forms a logical path for transmitting packets by logically controlling the communication line 61 and the communication line 62, which are provided between the transmission devices 1 and 2, and includes the following steps.

Step (1): The transmission device 1 reports the packet number (TxFCI), which is sent to the other transmission device 2 via the operation system communication line 61, from the transmission device 1 to the other transmission device 2 at regular intervals, and retains the packet number in association with the standby system communication line 62.

Step (2): The transmission device 2 reports the packet number (RxFCI′), which is received from the other transmission device 1 via the communication line 61, from the transmission device 2 to the other transmission device 1 at regular intervals, and retains the packet number in association with the communication line 62.

Step (3): The transmission device 1 initiates counting of the packet number, which is sent to the transmission device 2 via the communication line 62, as the sent packet number, which is retained in association with the communication line 62 set as an initial value, and the transmission device 2 initiates counting of the packet number, which is received from the transmission device 1 via the communication line 62, as the received packet number, which is retained in association with the communication line 62 set as an initial value when the operation system is switched from the communication line 61 to the communication line 62.

Since the transmission method according to the present embodiment includes the same configurations as the transmission system according to the embodiment, the transmission method exhibits the same effects as the contents mentioned above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission method executed by a transmission system including a first transmission device, a second transmission device, a first communication line and a second communication line, the first communication line and the second communication line are provided between the first transmission device and the second transmission device, the transmission method comprising:
notifying, by the first transmission device, a number of packets transmitted from the first transmission device to the second transmission device via the first communication line, of the second transmission device at a predetermined interval;
storing the number of the transmitted packets in association with the second communication line;
notifying, by the second transmission device, a number of packets received from the first transmission device via the first communication line, of the first transmission device at a predetermined interval;
storing the number of the received packets in association with the second communication line; and
when an operation system is switched from the first communication line to the second communication line,
initiating, by the first transmission device, counting of a number of packets transmitted from the first transmission device to the second transmission device via the second communication line using the number of transmitted packets stored in association with the second communication line set as an initial value; and
initiating, by the second transmission device, counting of a number of packets received from the first transmission device via the second communication line using the number of received packets stored in association with the second communication line set as an initial value.

2. The transmission method according to claim 1, further comprising:
notifying, by the first transmission device, a number of packets transmitted to the second transmission device via the second communication line, of the second transmission device at a predetermined interval; and
notifying, by the second transmission device, a number of packets received from the first transmission device via the second communication line, of the first transmission device at a predetermined interval.

3. The transmission method according to claim 2, further comprising:
calculating, by the first transmission device, a packet loss by calculating a difference between an amount of change per predetermined period of time of the number of packets transmitted to the second transmission device from the first transmission device via the second communication line, the number being counted by the first transmission device, and an amount of change per predetermined period of time of the number of packets received by the second transmission device, the amount being notified from the second transmission device.

4. The transmission method according to claim 1, further comprising
receiving, by the first transmission device, a number of packets transmitted to the first transmission device from the second transmission device via the second communication line, from the second transmission device at a predetermined interval.

5. The transmission method according to claim 2, further comprising
calculating, by the first transmission device, a packet loss by calculating a difference between an amount of change per predetermined period of time of the number of packets received from the second transmission device via the second communication line, the number being counted by the first transmission device, and an amount of change per predetermined period of time of the number of packets transmitted to the first transmission device from the second transmission device via the second communication line, the amount being notified from the second transmission device.

6. The transmission method according to claim 1, further comprising
updating, by the first transmission device, the number of packets transmitted to the second transmission device via the second communication line so as to be a same as the number of packets transmitted to the second transmission device via the first communication line, the number being counted by the first transmission device, before an operation system switches to the second communication line from the first communication line.

7. The transmission method according to claim 1, further comprising
updating, by the second transmission device, the number of packets received from the first transmission device via the second communication line so as to be a same as the number of packets received from the first transmission device via the first communication line, the number being counted by the second transmission device, before an operation system switches to the second communication line from the first communication line.

8. The transmission method according to claim 1,
wherein the first communication line and the second communication line belong to a common link aggregation group (LAG).

9. A transmission system comprising:
a first transmission device;
a second transmission device;
a first communication line; and
a second communication line,
wherein the first communication line and the second communication line are provided between the first transmission device and the second transmission device, and
wherein the first transmission device is configured to:
notify a number of packets transmitted from the first transmission device to the second transmission device via the first communication line, of the second transmission device at a predetermined interval, and
store the number of transmitted packets in association with the second communication line, and
wherein the second transmission device is configured to:
notify a number of packets received from the first transmission device via the first communication line, to the first transmission device from the second transmission device at a predetermined interval,
store the number of received packets in association with the second communication line, and
when an operation system is switched from the first communication line to the second communication line,
the first transmission device is configured to initiate counting of a number of packets transmitted from the first transmission device to the second transmission device via the second communication line using the number of transmitted packets stored in association with the second communication line set as an initial value, and
the second transmission device is configured to initiate counting of a number of packets received from the first transmission device via the second communication line using the number of received packets stored in association with the second communication line set as an initial value.

10. A transmission device coupled to another transmission device via a first communication line and a second communication line, the transmission device comprising:
a memory; and
a processor coupled to the memory and configured to:
notify a number of packets transmitted from the transmission device to the another transmission device via the first communication line, of the another transmission device at a predetermined interval,
store the number of transmitted packets in association with the second communication line, and
initiate counting of a number of packets transmitted from the transmission device to the another transmission device via the second communication line using the number of transmitted packets stored in association with the second communication line set as an initial value, when an operation system is switched from the first communication line to the second communication line.
